(19) United States
(12) Patent Application Publication
(10) Pub. No.: US 2026/0112283 A1
(43) Pub. Date: Apr. 23, 2026

(54) EGO DYSTONIC VOICE CONVERSION FOR REDUCING STUTTERING

(71) Applicant: Benno Belke, Berlin (DE)

(72) Inventor: Benno Belke, Berlin (DE)

(21) Appl. No.: 19/167,956

(22) PCT Filed: Apr. 2, 2024
(86) PCT No.: PCT/EP2024/058963

§ 371 Date: Sep. 23, 2025

Related U.S. Application Data
(60) Provisional application No. 63/457,902, filed on Apr. 7, 2023.

(30) Foreign Application Priority Data
Mar. 29, 2023 (EP) 23165094.6
Apr. 7, 2023 (EP) 23167196.7

(51) Int. Cl. G09B 5/04; G10L 19/018; G10L 25/30; G10L 25/51; G10L 25/78; H04S 7/00

(52) U.S. Cl. CPC G09B 5/04; G10L 19/018; G10L 25/30; G10L 25/51; G10L 25/78; H04S 7/304; H04S 2400/11

(57) ABSTRACT

The present disclosure relates to devices, systems, computer programs as well as a computer-implemented voice conversion method for reducing stuttering. The voice conversion preferably takes place in a mobile electronic user device, an audio processing device integrated into a wearable hearing system or a server. The devices, systems, computer programs and methods are preferably configured for carrying out the following steps: receiving input audio information from an audio sensor device (106), which comprises at least one verbal utterance in a natural voice of a user; carrying out a voice conversion (118) for generating output audio information in an ego-dystonic target voice, in that the at least one verbal utterance is converted as if the same speech content was produced by a different speaker; prompting a reproduction, in particular a binaural reproduction, of the voice-converted output audio information to the user at least approximately in real time as feedback to the speaking of the user.

### TECHNICAL FIELD

The present invention generally relates to the technical field of digital audio processing and in particular to devices and systems for the direct improvement of speech fluency in speech fluency disorders, in particular stuttering, by means of voice conversion. The said voice conversion is an ego dystonic voice conversion within the context of the present invention.

### BACKGROUND

Approximately 1% of the world population suffers from developmentally lasting stuttering [Bloodstein O. Ratner N. B. & Brundage S. B. (2021). A handbook on stuttering (Seventh). Plural Publishing]. Even though the majority of those affected undergo a specific treatment, such as a speech therapy, stuttering usually persists throughout the entire lifespan [Boyce J O, Jackson V E, van Reyk O, Parker R, Vogel A P, Eising E, Horton S E, Gillespie N A, Scheffer I E, Amor D J, Hildebrand M S, Fisher S E, Martin N G, Reilly S, Bahlo M, Morgan A T. Self-reported impact of developmental stuttering across the lifespan. Dev Med Child Neurol. 2022 October; 64(10):1297-1306. doi: 10.1111/dmcn.15211. Epub 2022 Mar. 21. PMID: 35307825]. There is thus a large need for methods and systems for temporarily improving the fluency, in particular by reducing stuttering.

Conventional apparatus-supported solutions typically use the method of the altered auditory feedback (abbreviation “AAF”). Here, the speech signal of a person is electronically altered in order to temporarily increase the speech fluency. Two known voice modification methods are (a) delayed auditory feedback, where the voice is played back with an offset of 50-100 milliseconds and (b) frequency altered feedback, where the voice is reproduced with a pitch, which is changed up or down, typically by ¼ to 1 octave.

Numerous peer-reviewed studies have shown an immediate reduction in the frequency of stuttering in response to the application of the Altered Auditory Feedback (AAF), for example [Hudock D, Kalinowski J., 2014. “Stuttering inhibition via altered auditory feedback during scripted telephone conversations”. Int J Lang Commun Disord. 49(1):139-47.; Lincoln, Michelle & Packman, Ann & Onslow, Mark. (2006). Altered auditory feedback and the treatment of stuttering: A review. Journal of fluency disorders. 31. 71-89. 10.1016/.jfludis.2006.04.001.; Unger J. P., Glück C. W., Cholewa J., 2012. “Immediate effects of AAF devices on the characteristics of stuttering: a clinical analysis” J Fluency Disord 37:122-34.].

Various problems are known for these conventional AAF-based solutions:

On the one hand, the effect of AAF in treating stuttering is under-specified. In particular, the neural mechanisms for improving speech-fluency in stuttering, as well as the high individual variance of this effect, are largely unexplained [Chang S E, Garnett E O, Etchell A, Chow H M. Functional and Neuroanatomical Bases of Developmental Stuttering: Current Insights. Neuroscientist. 2019 December; 25(6):566-582. doi: 10.1177/1073858418803594. Epub 2018 Sep. 28. PMID: 30264661; PMCID: PMC6486457]. Due to these missing knowledge bases, the current market-leading AAF-based “Speech Easy” device by the Janus Group (US) has also been referred to as pseudo-scientific [Bothe, Anne & Finn, Patrick & Edge, Robin. (2007). Pseudoscience and the SpeechEasy: Reply to Kalinowski, Saltuklaroglu, Stuart, and Guntupalli (2007). American Journal of Speech-language Pathology—AM J SPEECH-LANG PATHOL. 16. 77-83. 10.1044/1058-0360(2007/010)]. For example, specific assumptions are missing about the effectiveness of the 128 voice modulation effects in the AAF method [“Adaptation resistant anti-stuttering devices and related methods”, U.S. Pat. No. 7,591,779 B2] described by Kalinowski et al. (2009) and the necessary intensity thereof, in order to achieve a reduction in stuttering for a certain person. The resulting “trial and error” approach is inefficient for both clinical application and technical development of AAF solutions. Conventional AAF devices and methods thus typically require a setup phase, which is carried out by an expert, such as an audiologist trained in AAF, in order to optimize the AAF device for the speech fluency of a specific person through “trial and error” testing. This setup phase can be cumbersome or difficult for the user, in particular, if no such expert is regionally available.

Moreover, conventional AAF methods cannot preserve the natural quality of a human voice due to their inherent design. For example, a time-delayed feedback of one's own voice by 70 milliseconds can be perceived as mechanical echo and a pitch increase of more than 5 half-tones can resemble a “Micky Mouse” voice (“helium effect”) [https://www.spektrum.de/frage/warum-bekommt-man-von-helium-eine-hohe-stimme/2057211]. Moreover, pitch shifting disrupts harmonic structures between fundamental frequencies and overtones (harmonics) that are typical for human voices, which can make the voice seem unnatural, particularly if the shift is large. Since especially complex combinations of time delay and pitch shift contribute to improving the speech fluency in stuttering [Hudock, Daniel & Kalinowski. Joseph. (2014). Stuttering inhibition via altered auditory feedback during scripted telephone conversations. International journal of language & communication disorders/Royal College of Speech & Language Therapists. 49. 139-47. 10.1111/1460-6984.12053.], the reproduction of the human voice is distorted in conventional solutions. User acceptance can be greatly reduced by hearing such unnatural voice feedback, especially with prolonged everyday use. Furthermore, it is well-known to someone skilled in the art that pitch-shifted and delayed speech-feedback can adversely affect speech control. For instance, delayed feedback often leads to an unintended slowing of speech rate [Callan A, Callan D E (2022) Understanding how the human brain tracks emitted speech sounds to execute fluent speech production. PLoS Biol 20(2): e3001533. https://doi.org/10.1371/journal.pbio.3001533], which may sound and feel unnatural. Additionally, users may compensate for perceived pitch shifts subconsciously and adjust their pitch—a phenomenon described by the Lombard Effect—which may be unpleasant during continuous speech episodes. Moreover, complex AAF distortions can impair speech intelligibility to a considerable extent, as speech-perception is naturally attuned to human-like voices.

A further disadvantage of conventional AAF methods is their large unexplained inter-individual effectiveness [Lincoln, Michelle & Packman, Ann & Onslow, Mark. (2006). Altered auditory feedback and the treatment of stuttering: A review. Journal of fluency disorders. 31. 71-89.]. While AAF solutions according to the prior art can be beneficial for some people suffering from stuttering, this is not the case for others. Due to the insufficient knowledge about the specific mode of action of AAF-based solutions, it is currently not possible to predetermine which features an AAF signal must possess to effectively reduce stuttering in a specific individual. This is why there are currently no suggestions or proposals in the prior art on how conventional devices can be specifically adapted to the requirements of an individual user, in order to maximally improve that user's fluency. With the context of the invention, an individual user, like a stutterer, has specific requirements that needs to be adapted by the ego dystonic voice conversion as disclosed herein.

Conventional AAF methods also have the known problem that the effectiveness of the voice modification quickly diminishes because the user becomes familiarized with the voice modification. When applied regularly by the user, the stuttering-reducing effect can often not be maintained. Study results show that a continuous application of AAF methods can already become ineffective for the improvement of the fluency in the case of stuttering after only 10 minutes [Armson, J., & Stuart, A. (1998). Effect of extended exposure to frequency altered feedback on stuttering during reading and monologue. Journal of Speech, Language and Hearing Research, 41, 479-490; Ingham, R. J., Moglia, R. A., Frank. P., Ingham, J. C., & Cordes, A. K. (1997). Experimental investigation of the effects of frequency-altered auditory feedback on the speech of adults who stutter. Journal of Speech, Language and Hearing Research, 40, 361-372.]. The quickly diminishing fluency effect can not only cause frustration for the user but also may make current AAF methods unsuitable for daily application in many cases. To avoid this, a solution exists, in the case of which the voice modifications are changed randomly or quasi randomly [Kalinowski et al., 2009, Adaptation resistant anti-stuttering devices and related methods, U.S. Pat. No. 7,591,779 B2]. However, interfering acoustic events can result, which distract from the current hearing event, such as sudden change between voice modulation types (for example of echo to reverso echo) or between parameter settings (for example change of the time delay by +/−50 milliseconds). Such unintended acoustic artefacts may further decrease the user's compliance with AAF methods.

In order to successfully use an AAF in daily speaking situations, it is further also important that only the voice of the user is modified and other voices are ignored. To attain this, conventional methods of the digital signal processing are used in conventional methods for recognizing the voice activity of the user or of the user-unspecific speech recognition [Kalinowski et al., 2000, “Methods and devices for delivering exogenously generated speech signals to enhance fluency in persons who stutter” U.S. Pat. No. 6,754,632 B1; Jiang et al., 2004, “Device and method for reducing stuttering”, European patent 1 817 769 B1]. However, these methods cannot make a reliable differentiation between verbal utterances and non-verbal utterances of the user, such as throat clearing, coughing or laughing. Non-utterances can be incorrectly recognized as verbal utterances of the user and can thus be subjected to an unwanted distortion, which can lead to irritation in the auditory impression. This further limits the user acceptance of known devices. Users have an obvious interest in that their listening experience remains as natural as possible and that every acoustic intervention is limited to actual speaking episodes, in order to improve the flow of speech.

Lastly, conventional AAF methods, such as in Kalinowski et al. (2009) [Kalinowski et al., 2009, Adaptation resistant anti-stuttering devices and related methods, U.S. Pat. No. 7,591,779 B2], often use devices, which are optically similar to classical hearing aids and thus increase the risk of a social stigmatization. Especially among children, who are already subjected to negative attitudes from peers towards hearing aid wearers [Wheeler L R, Tharpe A M. Young Children's Attitudes Toward Peers Who Wear Hearing Aids. Am J Audiol. 2020 Jun. 8; 29(2):110-119. doi: 10.1044/2019_AJA-19-00082. Epub 2020 Mar. 17. PMID: 32182092; PMCID: PMC7839021.], this can increase the inhibition threshold for wearing AAF devices.

These problems may explain the results of a user survey of the “American National Stutterer Association” (accessed in November 2021), which show that conventional AFF devices in daily speaking situations are used, at best, in isolated situations, such as, for example, when making phone calls. In spite of the revolutionary progress in relevant fields of audio technology, the prior art in the field of the AAF technology has hardly changed since the 90s.

It is thus an object of the present disclosure to provide technologies, which are geared towards alleviating or eliminating one or several of the above-identified deficiencies of the prior art either individually or in any combination.

In the present disclosure a method of ego dystonic voice conversion will be disclosed for the direct improvement of speech fluency in speech fluency disorders, in particular for reducing stuttering.

Wang et al. describe, for instance, a hybrid modeling approach for mere voice conversion in order to allow for a source style transfer based on a recognition-synthesis framework, which can transfer the style of source speech (like timbre and prosody) to the converted speech [Zhichao Wang et al.: “Enriching Source Style Transfer in Recognition-Synthesis based Non-Parallel Voice Conversion”, ARXIV.ORG, Cornell University Library, 201 Online Library Cornell University Ithaca, NY 14853, 16 Jun. 2021].

However, Wang et al. do not address the beneficial use (i.e. the speech fluency enhancing effect) of voice conversion methods or systems in the case of fluency disorders nor how such voice conversion methods or systems need to be configured for this purpose, as will be only disclosed within the context of the present invention. More specifically, Wang et al. do not address the generation of an ego-dystonic voice (including a personalized, user-specific anti-voice, as will be further disclosed herein) for a person who stutters that makes it technically possible to sensorially mute (i.e., bypass, suppress, inhibit, disengage) the neural mechanisms (i.e., underlying processes, activation of neural circuitry) that are typically aberrant in people who stutter. Within the context of the present invention, it will be disclosed that an ego-dystonic voice (including the said anti-voice) can effectively/efficiently mute the so-called “auditory feedback loop”, which is a natural phenomenon in speech production and typically aberrant in stuttering. Because the auditory feedback loop is linked to a sensory encoding of the stutterer's voice as “own voice”, an ego-dystonic voice can deceive this sensory recognition of the stutterer's “own voice” as a “foreign voice”, with the immediate effect of improved fluency, preferably significantly improved fluency, in real time or approximately in real time.

Moreover, Wang et al. do not address another aspect of the present invention, disclosed herein for the first time, of a continuous, preferably continuously changing, generation of such an ego-dystonic voice (including the said anti-voice) for a person who stutters that makes it technically possible to maintain the fluency effect of the ego-dystonic voice (or said anti-voice) even during extended periods of application, that is, without a diminishing or weakening fluency effect, preferably without a significantly diminishing or weakening fluency effect. Because such continuous, preferably continuously changing, generation of an ego-dystonic voice (including the said anti-voice) cannot be sensorially adapted by the user (i.e., it cannot be sensorially encoded as “own voice”; it remains sensorially encoded as a “foreign voice”; it remains sensorially unfamiliar even with repeated exposure). Thereby, a continuous, preferably continuously changing, generation of an ego-dystonic voice (including a personalized anti-voice) ensures a sustained improvement of the fluency, preferably a significantly sustained improvement of the fluency, in real time or approximately in real time, even when used for a longer period, that is even when exposed to such a voice for more than three hours, preferably more than one hour, most preferably for more than 10 minutes. Accordingly, a significant aspect of the present invention lies not only in blindly converting a stutterer's “own voice” into another “target voice”, but also in an underlying algorithm that maintains the ego-dystonia of the stutterer's own voice/speech.

Moreover, Wang et al. do not address another aspect of the present invention, disclosed herein for the first time, of generating an ego-dystonic voice in a personalized manner. The personalization entails computational steps configured to convert the user's voice into an anti-voice, i.e., a voice that is perceived as maximally or sufficiently different in at least one aspect from the subject's “own voice”. Since each speaker possesses a unique voice identity, characterized by an individual acoustic imprint (resulting amongst other things from the unique configuration of a speaker's vocal tract) merely converting a voice through a generic conversion system, such as, for example, Wang et al.'s, into “any other voice” does not consistently (or at all) yield a fluency improvement for a person who stutters. This is because the target voice might inadvertently resemble the user's own voice and is sensorially recognized as the “own voice”, or, over time, become sensorially recognized as the “own voice”, especially if the perceptual voice-similarity is high. Accordingly, a significant aspect of the present invention lies not only in blindly converting a stutterer's “own voice” into another “target voice”, but also in an underlying algorithm that generates the ego-dystonia of the stutterer's own voice/speech by means of outputting a user-specific anti-voice that is maximally or sufficiently dissimilar in at least one characteristic central for the neural or sensorial recognition of a voice-identity.

In other words, a generic voice conversion system, such as, for example the one described by Wang et al., fails to adhere to the fundamental neural principles of human voice recognition and adaptation, which are essential for inducing improvements in speech fluency for individuals who stutter in the case of voice conversion. Therefore, the conversion into an ego-dystonic voice necessitates the instant invention, which will now be detailed as follows.

### SUMMARY OF THE INVENTION

The present disclosure generally relates to technologies of voice conversion for generating an ego-dystonic voice identity, which, when reproduced as acoustic feedback when a user speaks, is identified by this user in a sensory or neural manner as “different voice”. The technologies disclosed herein are based on knowledge-based insights, which are disclosed herein for the first time, about the neural effect of such an ego-dystonic voice conversion on the improvement of the flow of words (fluency) in fluency disorders, in particular in the case of stuttering.

With the context of the invention the technical feature(s) “ego-dystonic voice/speech”, “ego-dystonic”, “ego-dystonia” or similar terms denote:
a technically generated, human-like (i.e. authentically, approximately authentically or roughly authentically sounding) target voice that is used as feedback for a user's speech and perceived by this user as “another person's voice” (i.e., a “foreign voice”, and/or a voice that the user perceives as not their own voice, and/or a voice that is perceived as if produced by a different speaker). The source voice being that of the user, particularly a person who stutters. The term “perceived as” refers to sensory-based recognition of human voices under real-time or near real-time conditions. The term “human-like” refers to a high perceptual similarity to an actual human voice, with at least a 70% similarity, preferably 80%, and most preferred 90%, as measured, for example, by respective voice-similarity algorithms, as disclosed herein.

This ego-dystonic voice may be characterized by:
at least one distinguishing characteristic essential for altering auditory recognition of voice identity (speaker identity), contrasting or sufficiently different from the subject's own voice. This includes, but is not limited to, transforming gender characteristics of the voice (e.g., from male to female or vice versa), altering age-related characteristics (e.g., from older to younger sounding or vice versa), modifying vocal tract dimensions (e.g., from stretched to shortened, wide to narrow, or vice versa), or changing linguistic dialects. These modifications in speaker identity are employable individually or in combination. These modifications may include one, many, or all characteristics of a different target-speaker (e.g., in a ‘speaker-swap’), as long as there is a perceptually noticeable difference between the voice identity of the user and the target speaker. In this case, the target speaker's voice might be that of a real (living or deceased) person, a generic (computer generated) person, or a hybrid between both;
and/or a constant or continuous change in at least one of the aforementioned distinguishing characteristics, essential for altering auditory recognition of voice identity (speaker identity). In this aspect of the invention, the ego-dystonic voice of a user, preferably a stutterer, is continuously changed to prevent adaptation by the user, thereby avoiding recognition of it as “own voice”. Instead, the constant or continuous change aims to maintain the constant sensory or neural recognition of the target-voice as “other's voice” (or “foreign voice”);
additionally, in another aspect of the invention, the ego-dystonic voice is the “anti-voice”; i.e., a technically generated, personalized voice of a subject/stutterer, perceived as maximally or sufficiently different in at least one aspect from the subject's “own voice”.

Moreover, in some embodiments of the invention, the natural pitch (f0) of the voice/speech is maintained for the ego-dystonic voice/speech or anti-voice. This maintenance of pitch is perceived by the stutterer as pleasant (because it prevents intuitive counteracting adjustments to the perceived pitch differences by the user), while remaining effective in normalizing speech fluency.

With the context of the invention, the ego-dystonic voice can be objectively detected as “different” or even “maximally different” from a subject's/stutterer's “own voice” on various levels using a suitable technical algorithm.

Manipulation of the at least one distinguishing characteristic, essential for altering auditory recognition of voice identity (speaker identity), can be achieved by addressing one or more of the following acoustic properties, either individually or in combination:
1. Formant Frequencies (Timbre): Manipulating the formant frequencies, which are typically measured in Hz, to change the vocal tract characteristics that define the voice's timbre.
2. Spectral Features: Altering the spectral envelope, which includes varying the intensity and distribution of harmonics across the frequency spectrum, often quantified using Mel-frequency cepstral coefficients (MFCCs) or similar parameters.
3. Temporal Characteristics: Modifying parameters like phoneme duration (measured in milliseconds), speech rate (words per minute), and rhythmical patterns to match the target voice's temporal profile.
4. Prosody: Adjusting pitch contour (intonation pattern over sentences), stress patterns (emphasis on certain syllables or words), quantified using prosodic features like pitch variation and rhythm metrics.
5. Articulation and Pronunciation: Refining articulatory features using parameters like voice onset time for consonants, vowel formant transitions, involving phonetic analysis and synthesis techniques.
6. Dynamics and Loudness: Controlling the dynamic range, measured in decibels (dB), to match the loudness patterns and variations of the target voice.
7. Voice Quality Attributes: Modifying parameters like jitter (frequency variation), shimmer (amplitude variation), and harmonics-to-noise ratio (HNR) to replicate voice qualities like breathiness or nasality.
8. Non-linguistic Sounds: Including parameters for breathiness (measured through airflow and breath noise characteristics) and laughter or sigh patterns (characterized by specific spectral and temporal properties).

The respective methods and techniques (1.-8.) are well known to a person skilled in the art of voice conversion.

One aspect of the present disclosure refers to an audio processing device. The audio processing device can, for example, be or comprise, respectively, a mobile electronic user device, an audio processing device integrated into a wearable hearing system or a server or can be integrated therein, respectively.

According to one aspect, the audio processing device can be configured for receiving input audio information from an audio sensor device. The input audio information can comprise at least one verbal utterance in a natural voice of a user. The input audio information can be detected, for example, by means of an audio sensor device or can be provided by it, respectively. The audio processing device can be configured for carrying out a voice conversion for generating output audio information in an ego-dystonic target voice. The at least one verbal utterance is preferably converted thereby as if the same speech content was produced by a different speaker. The audio processing device can be configured to prompt a reproduction of the voice-converted output audio information to the user. The reproduction can take place in real time or at least approximately in real time, in particular as feedback to the speaking of the user. The audio processing device can in particular be a mobile electronic user device, an audio processing device integrated into a wearable hearing system or a server or can comprise them, respectively, or be integrated into them, respectively. The implementation variations mentioned here as an overview will be described in more detail further below.

As already mentioned, the created output voice preferably comprises an ego-dystonic target voice. An ego-dystonic target voice is preferably to be understood to be a voice, which the user identifies in a sensory or neural manner as not his own and/or foreign and/or other voice, in particular by means of a neural mechanism (for example of the auditory cortex) to identify the own voice. In additional or alternative aspects, an ego-dystonic target voice can be identified as such by any one of the definitions and technologies disclosed here, e.g. by using an algorithm to evaluate the voice similarity. Such algorithms are known, for example, from the field of the forensic voice analysis and speaker identification systems.

According to this aspect, such an ego-dystonic target voice is preferably created by means of technologies and/or methods of voice conversion and is reproduced as output voice to the user as acoustic feedback to his speaking.

In contrast to the known solutions, the present disclosure provides significant advantages, which are summarised here only as an overview and without limitation and which will be described in detail further below:
1. In one aspect of the present disclosure, the ego-dystonic voice created by means of voice conversion, compared to conventional AAF solutions, offers the advantage that it specifically and efficiently influences the neural cause for the improved flow of speech in stuttering. Surprising evidence relating to the neural effect of an ego-dystonic voice created by means of voice conversion and findings about it, which are disclosed here for the first time, prove this. The effectiveness for the improvement of the fluency, in particular in stuttering, can be increased by means of voice conversion according to the invention by means of systematically influencing the neural recognition of a user's own voice. In other words, the disclosed method of an ego dystonic voice conversion is more efficient in affecting these neural aspects of stuttering, according to the scientific rationale disclosed herein, and can potentially offer better results in improving speech fluency for people who stutter compared to the prior art in AAF technologies.
2. In addition, it becomes possible for the first time to preserve the authenticity of a human voice within an AAF solution. In contrast to conventional AAF solutions, vocal distortions due to echo, pitch or frequency modifications, which unavoidably impact the natural representation of a voice, are no longer required. Users can thus hear their speech-related feedback in the fine nuances of a human voice, without it being distorted in an “effect-oriented manner”, as before, by adding static echoes, filters or pitch changes.
3. It is made possible in certain embodiments to maintain the natural pitch (fundamental frequency, f0) of the user because a change of the fundamental frequency, which raises the voice unnaturally (“Micky Mouse” effect) or lowers it (“Darth Vader” effect) is no longer necessary in these embodiments. In contrast to AAF-based solutions, which are based on pitch changes or include them, users can thus hear their own voice in the pitch they are familiar with in these embodiments.
4. The present disclosure increases the flexibility in the technical design of AAF solutions, in that a virtually unlimited number of ego-dystonic target voices (voice profiles) can be used. In contrast to conventional AAF solutions, which are limited to a narrow variation of the underlying audio effects (e.g. to a variation of +/−100 milliseconds during the time daily or to +/−12 half-tones in the case of the pitch change), the present disclosure provides for a more precise adaptation to individual preferences, needs and requirements of a user by means of the increased bandwidth of ego-dystonic target voices.

The degree of change between the natural voice of a user and an ego-dystonic target voice is preferably of such extent that, when being reproduced as acoustic feedback in response to the speaking of a user, the user does not identify the target voice in a sensory or neural manner as his own voice.

Alternatively, the preferred degree of change can be determined by a suitable algorithm for evaluating voice similarity, such as a biometric speaker identification system, especially if this algorithm correlates with a human's subjective sense of similarity when hearing human voices. The degree of change here corresponds to at least to the degree at which the target voice is no longer identified as the target voice of the user. For example, the degree of dissimilarity between an ego-dystonic voice and the natural voice of the user, which is quantified by means of any methods described in this disclosure, can be at least 10%, preferably at least 20%, even more preferably at least 30%. Examples of methods for quantifying the degree of dissimilarity are described in this disclosure. The knowledge-based findings, which are disclosed here for the first time, about the neural impact of such an ego-dystonic voice conversion on the speech fluency in stuttering are supported by various phenomena:

Intentional voice changes, for example by imitating another person or a foreign dialect, by voiceless speaking (whispering) or by speaking in an uncommon pitch, are different methods typically used by those affected, in order to achieve an immediate improvement of their speech fluency. According to the “Stuttering Treatment and Research Trust” (accessed in June of 2021), such spontaneous voice changes, initiated by those affected themselves, can yield an almost complete normalization of the fluency, partially even in severe cases of stuttering. For these and similar phenomena, such as choral speaking, which have been previously considered in isolation, a uniform explanation or description of a causal neural mechanism for the reduction of stuttering is not known [Bloodstein O. Ratner N. B. & Brundage S. B. (2021). A handbook on stuttering (Seventh). Plural Publishing.]. Therefore, the underlying speech-enhancing effect has not been able to be used specifically or efficiently in technology so far. The device described here makes it possible for people who stutter to systematically utilize (in an apparatus-supported manner) the effect of improving the speech fluency when speaking with a foreign voice identity for the first time, namely with the above-mentioned ego-dystonic target voice. Technologies and methods of voice conversion can be used for this purpose, as they are employed in various fields of application, such as film dubbing (replacing the voice of actors), in voice anonymization (protection of identity) or so-called text-to-speech applications (conversion of written words into spoken words). Voice conversion in terms of the present disclosure is preferably a computer-based technology or method for changing one voice into another, without changing the linguistic content. A verbal utterance of the user, which is included in the captured input audio information, is thereby preferably used to generate output audio information in an ego-dystonic target voice, in that the at least one verbal utterance is acoustically represented as if the same speech content was produced by a different speaker. A preferred computer-based process, which can be used to convert one voice into another, without changing the speech content, is referred to here as voice conversion (following the general convention).

The processes of voice conversion may typically consist, without being limited to those, of several key steps:
1. Analysis: The original speech signal undergoes spectral analysis where parameters like fundamental frequency (F0), formant frequencies, and Mel-frequency cepstral coefficients (MFCCs) are extracted. This step may involve signal processing techniques like Fourier transforms or linear predictive coding to capture the nuanced characteristics of the speaker's voice.
2. Transformation: The extracted features such as pitch (measured in Hertz), timbre (manipulated by adjusting formant frequencies), and temporal aspects (like duration and speech rate, measured in milliseconds or words per minute) are transformed. This could involve using algorithms to shift the F0 by a specific number of Hertz or altering the formant frequencies to match those typical of the target speaker's vocal tract characteristics.
3. Synthesis: The transformed acoustic features are then synthesized back into a speech signal using synthesis techniques like concatenative synthesis or parametric synthesis. Here, the challenge is to maintain natural prosody and intonation, which involves careful manipulation of pitch contours and duration patterns, ensuring that the synthesized speech mimics the natural flow and rhythm of human speech.
4. Refinement: Advanced machine learning algorithms, such as neural networks or deep learning models, may be employed to minimize artifacts and enhance the naturalness of the converted speech. This may involve training models on large datasets to learn the subtle characteristics of different voices and applying noise reduction techniques or smoothing filters to ensure the converted voice sounds as natural and clear as possible.

General technologies and methods of the voice conversion are described in the below-mentioned technical publications:
Dagar, D., Vishwakarma, D. K. A literature review and perspectives in deepfakes: generation, detection, and applications. Int J Multimed Info Retr 11, 219-289 (2022). https://doi.org/10.1007/s13735-022-00241-w
Sisman, Berrak & Yamagishi, Junichi & King, Simon & Li, Haizhou. (2020). An Overview of Voice Conversion and Its Challenges: From Statistical Modeling to Deep Learning. IEEE/ACM Transactions on Audio, Speech, and Language Processing. 29. 10.1109/TASLP.2020.3038524.
Walczyna T, Piotrowski Z. Overview of Voice Conversion Methods Based on Deep Learning. Applied Sciences. 2023; 13(5):3100. https://doi.org/10.3390/app13053100
Zhang, Mingyang & Sisman, Berrak & Zhao, Li & Li, Haizhou. (2020). DeepConversion: Voice conversion with limited parallel training data. Speech Communication. 122. 10.1016/j.specom.2020.05.004.
Zhao, Y., Huang, W.-C., Tian, X., Yamagishi, J., Das, R. K., Kinnunen, T., Ling, Z., Toda, T., 2020. Voice conversion challenge 2020: Intra-lingual semi-parallel and cross-lingual voice conversion. arXiv preprint arXiv:2008.12527.

According to some aspects disclosed herein, the present disclosure modifies such technologies and methods for generating an ego-dystonic target voice, in order to improve the fluency of a user. The ego-dystonic voice disclosed herein can thereby have one or several of the following properties:
Generally speaking, the ego-dystonic target voice is preferably a voice, which is identified by the user as foreign voice, wherein “identified by the user” refers in particular to a sensory or neural identifying in this context, in particular by means of a neural mechanism of the auditory cortex for identifying a voice of the user.
The ego-dystonic target voice can be a voice that is identified by an algorithm for evaluating voice similarity, such as a biometric speaker identification system, as a foreign voice, i.e., one that does not match the user's voice, especially if this algorithm correlates with the subjective sense of similarity a person experiences when hearing voices.
The ego-dystonic target voice can be a voice, which maintains the pitch of the natural voice of the user and/or the natural fundamental frequency F0 of the natural voice of the user. In this embodiment, users are thus able to hear their voice in its usual pitch in the feedback. This represents an improvement compared to conventional AAF-based solutions, which typically change the fundamental frequency (F0), in order to attain an effective reduction of stuttering.
The ego-dystonic target voice can be a voice, which has a lifelike or at least approximately lifelike voice naturalness.
The ego-dystonic target voice can be a voice, which maintains or approximately maintains the natural quality of a human voice or human speech. With naturalness being defined here as being recognized as human voice by respective algorithms known in fields such as speaker recognition or speaker identification.
The ego-dystonic target voice can be a voice, which cannot be created (in particular not solely) by conventional AAF devices.
The ego-dystonic target voice can be a voice, which is not (in particular not solely) based on a change of the pitch and/or a modification by means of frequency filtering.

According to the present disclosure, the term ego-dystonic voice or target voice, respectively, can also be understood as a voice, which represents an identical speech content (i.e. contained in the input audio information) with another voice identity (i.e. not identical with the user) and/or as a voice, in which speaking-dependent features (included in the input audio information) are converted as if the same speech content was produced by a different speaker voice, which is not identical with the user, and/or as a voice, which sounds like the voice of someone else, without changing the linguistic content and/or as a voice, with which the same wording of the verbal utterance is represented in a voice identity, which is not identical with the user and/or as a voice, which serves as feedback for the user when speaking, but which the user does not identify with his own voice and/or as a voice of a user, which was converted, so that it is recognized as the voice of another person by a suitable speaker identification system.

The playback of the output audio information to the user can comprise a binaural playback, preferably via a wearable hearing system, such as, for example, headphones. The advantage of binaural playback is that the user does not perceive his natural voice as speech feedback, allowing the associated aspects of the invention to fully exert their effect.

As already mentioned further above, the reproduction of the converted voice preferably takes place as immediate feedback to the speaking of the user. In this respect, the aspects of the invention disclosed herein can be considered to be a novel AAF solution. Compared to existing AAF solutions, the aspects of the invention disclosed herein have numerous technical advantages:

Aspects of the solution described herein preferably rely on a specific mode of operation for reducing of stuttering, which improves the effectiveness of the comparatively unspecific mode of operation of previous AAF solutions. This is so because the solution according to the invention is based on a direct sensory influence of the neural mechanism for the human recognition of one's own voice. Recent research findings have identified such a neural mechanism, which can selectively recognize one's own voice and differentiate it from foreign voices [Hosaka, T., Kimura, M. & Yotsumoto, Y. Neural representations of own-voice in the human auditory cortex. Sci Rep 11, 591 (2021). https://doi.org/10.1038/s41598-020-80095-6].

Carrying out the ego-dystonic voice conversion described herein is preferably configured to specifically and effectively deceive this neural mechanism of self-voice recognition, by altering only speaker-specific acoustic features of a verbal utterance that are relevant for identifying a speaker's identity. This ensures that the acoustic feedback naturally produced during speech is identified as a non-self (foreign) voice in neural processing. According to new findings, which are disclosed for the first time herein, such a deception of the neural recognition of one's own voice attained by means of ego-dystonic voice conversion, results in a decoupling of speech production from the simultaneous sensorimotor integration of the naturally produced acoustic feedback during speaking (also referred to as auditory feedback loop). Exactly this neural activity of the auditory feedback loop is impaired in stuttering. In response to a neural identification of the voice-converted target voice as “foreign voice”, this impaired activity is muted because it is functionally coupled to the neural identification of one's own voice. In other words: The speech processing is improved because the neural activity of the auditory feedback loop, which is impaired in stuttering, is irrelevant for the speech processing of a “foreign voice”. Consequently, speech fluency improves when applying the method of an ego-dystonic voice conversion as described herein.

This mode of action described for the first time herein explains the herein mentioned empirical result that speaking with an ego-dystonic voice identity can normalize the flow of speech specifically and efficiently.

The solution described in the disclosure at hand therefore has a specific effect (which can be determined ex ante) on the aforementioned neural mechanism of human self-voice recognition. This is so because, in response to a voice conversion, only speaker-dependent acoustic features, which are relevant for identifying the speaker identity, are preferably changed. Moreover, voice conversion involves a comprehensive manipulation of various acoustic features including timbre, speaking rate, rhythm, intonation, and articulation, enabling a highly nuanced manipulation of voice identity. In contrast, conventional AAF solutions have an unspecific effect (which cannot be determined ex ante) on this neural mechanism. This is so because conventional AAF voice modulations also change speaker-independent acoustic features, which are not relevant for the identification of the speaker identity. Moreover, while pitch shift can change certain acoustic properties of a voice, such as the frequency of sound waves and harmonics, it does not significantly alter the parameters that are crucial for recognizing an individual's voice identity, like timbre and formant frequencies or speaking rate, rhythm, intonation, and articulation. This is why voice recognition systems and humans can often still identify a voice even when the pitch is altered. In other words, pitch shifting, typically used in AAF devices, modifies the fundamental frequency. However, it is insufficient on its own for a convincing transformation of voice identity, as it does not inherently address aspects such as timbre, speaking rate, rhythm, intonation, and articulation. Consequently, the described solution allows for a much more differentiated influence on the auditory impression of the user's own voice, which is optimized with regard to effectiveness aspects and thus improves the efficiency of an AAF solution. An “audio processing device” as used herein is preferably a hardware device, which comprises a program stored therein, wherein the program is configured so that it executes a voice conversion according to any aspect of the invention disclosed herein. The audio processing device preferably comprises a processor.

In terms of the invention, a “processor” is preferably a programmable calculating device. The processor preferably comprises or has a software, which executes steps for receiving input audio information, converting the input audio information into an ego-dystonic target voice and transferring of output audio information. The processor can comprise several processor units, which are preferably configured for executing different functions and/or method steps of the invention. The processor units can preferably define hardware units of the processor, which do not have to be wired together.

The processor (or the processor unit) preferably has a memory and a computer code (software/firmware) for executing one or several method steps. The processor (or the processor unit) can also comprise a programmable printed circuit board, a microcontroller or another device for receiving and processing data signals from the audio sensor device or also from further processor units. The processor preferably further comprises a computer-usable or computer-readable medium, such as a hard drive, a random-access memory (RAM), a read-only memory (ROM), a flash memory, etc., on which a computer software or a code is installed. The computer code or the software for executing the method steps can be written in any programming language or a model-based development environment, e.g. in C/C++, C #, Objective-C, Java, Basic/VisualBasic, MATLAB, Python, Simulink, StateFlow, Lab View or Assembler, without being limited to these.

The expression that the audio processing device “is configured for” executing a certain method step, such as, e.g., the voice conversion, can describe a user-specific or standard software, which is installed on the audio processing device; in particular, on the processor, and which initiates and/or executes the required computing steps. The software preferably comprises a computer program, as further described in this disclosure. According to one aspect of the present disclosure, the voice conversion can take place at least partially on the basis of a machine learning model. The machine learning model can comprise or be a deep neural network (DNN), a recurrent neural network (RNN), a generative adversarial network (GAN) and/or a sequence-to-sequence mapping network (S2S). Accordingly, the solution described here can use advanced technologies of machine learning, in order to attain a voice modification, the naturalness and comprehensibility of which resembles real human voices, as proven for currently successful voice conversion systems [Zhao, Y., Huang, W.-C., Tian, X., Yamagishi, J., Das, R. K., Kinnunen, T., Ling, Z., Toda, T., 2020. Voice conversion challenge 2020: Intra-lingual semi-parallel and cross-lingual voice conversion. arXiv preprint arXiv:2008.12527]. Compared to conventional AAF-based solutions, which, by design, acoustically distort the voice of the user by means of pitch shifting and/or delay, the solution disclosed herein improves the speech intelligibility in the feedback and thus the general hearing comfort. The voice conversion system can simultaneously be improved continuously without hardware changes being required. The effectiveness of the target voice, which is made available to the user, can be constantly improved to improve the flow of speech. The target voice can be improved continuously, for example on the basis of input audio information, which characterizes the voice of the user. The continuous improvement can also take place on the basis of a quantification of the improvement of the fluency of the user when different ego-dystonic target voices are offered. For instance, the present invention may encompass a machine learning-based, self-adaptive model that dynamically alters audio parameters of the target voice, such as formant frequencies (timbre) and harmonics, in response to indicators of speech fluency. This model continuously refines these adjustments based on successful speech outcomes, which may include, for example, a reduction in the frequency of stuttering events for a specific user or user group. Through this iterative process, the model is capable of customizing audio feedback for each individual, thereby optimizing speech fluency via personalized auditory manipulation.

Following the above, according to one aspect of the invention, the effectiveness of the target voice, which is made available to the user, can be constantly improved to improve the flow of speech. The target voice may be improved continuously, for example on the basis of input audio information, which characterizes the voice of the user. The continuous improvement may take place on the basis of a quantification of the improvement of the fluency of the user when different ego-dystonic target voices are offered. For instance, the present invention may encompass a machine learning-based, self-adaptive model. The model may dynamically alter one or more audio parameters of the target voice, such as formant frequencies (timbre) and harmonics, in response to indicators of speech fluency. The model may continuously refine these adjustments based on successful speech outcomes, which may include, for example, a reduction in the frequency of stuttering events for a specific user or user group. Through this iterative process, the model is capable of customizing audio feedback for each individual, thereby optimizing speech fluency via personalized auditory manipulation.

The system can also comprise means for comparing the voice features of different users to the improvement of the fluency in the case of different target voices. Such data can be provided, e.g., in a matrix in a cloud and can be used to generally improve the allocation of ego-dystonic target voices to users.

The machine learning model can be configured to carry out one or several of the following operations:
reproducing individual natural and/or synthetic speaker voices, which are used for the machine learning;
generating new speaker voices, which are not used for the machine learning.

According to one aspect of the present disclosure, the voice conversion, or at least parts thereof, can be carried out in a language-dependent manner (intra-lingually) or cross-lingually. According to one aspect of the present disclosure, the voice conversion, or at least parts thereof, can take place in a gender-dependent manner (intra-gendered) or in a gender-independent manner (cross-gendered).

According to one aspect of the present disclosure, the ego-dystonic target voice can be a voice, which deviates in at least one of the following features from the natural voice of the user: stretching, shortening, widening, constriction of the physiological vocal tract of the user. Insofar as the feature can be determined quantitatively, the deviation is preferably at least 10%, preferably at least 20%, even more preferably at least 30%.

According to one aspect of the present disclosure, the voice conversion can comprise a (digital) audio signal processing for converting at least a portion of the speech content with the natural voice of the user into a voiceless language of whispering. Combinations of these aspects are also possible. These aspects have the advantage, among other things, that the created output voice (target voice), despite its ego-dystonic voice identity, is perceived as natural, i.e., human voice and not as a distorted or otherwise altered version of one's own voice.

According to one aspect of the present disclosure, which can also be realized independently of the aspects, which are otherwise disclosed here, the ego-dystonic target voice can comprise an anti-voice. The anti-voice is preferably in particular a voice, which deviates maximally or at least significantly or in more than in a specified measure from the natural voice of the user in at least one voice feature; in particular, in at least one speaker-dependent and/or non-lingual voice feature. The solution described here can thus be personalized to a user-based anti-voice in order to maximize the perceptual deviation between the natural voice of the user and the converted voice.

The at least one voice feature can thereby comprise, for example, one or several of the following properties:
one or several speaker-dependent spectral properties, which depend directly or indirectly on the configuration of the vocal tract, such as, for example, “Mel-frequency cepstral coefficients (MFCCs)”, “linear prediction cepstral coefficients (LPCCs)” and/or “perceptual linear prediction coefficients.
one or several speaker-dependent prosodic properties, such as, for example, “instantaneous energy”, “intonation”, “speech rate”, and/or “unit durations”.
one or several speaker-dependent features of the way of speaking; in particular of the linguistic dialect.
one or several of the aforementioned properties described herein.

Compared to a non-personalized method, such a personalization by means of the above aspects of the anti-voice can be more effective because the individual degree of perceptual deviation is considered. The expectation of a higher effectiveness is based on the following reasons:
It came as a surprise that the effect of the fluency in stuttering depends on the degree of the perceptual dissimilarity between the ego-dystonic target voice and the natural voice of the user. A converted target voice that maximizes this deviation on a personal basis can, therefore, be expected to increase the effectiveness compared to a converted voice randomly assigned to the user. This observation can be explained in a plausible manner by the stronger impact on the above-described neural recognition of one's own voice, so that the risk of an unwanted activation of the auditory feedback loop of the user can be very reliably avoided.
The deception of self-voice recognition, as described above, requires that the perceptual deviation of a converted voice compared to the natural voice of the user is pronounced sufficiently strongly. Whether this is achieved needs to be determined individually, which is why a personalized approach to voice conversion is methodologically superior to a non-personalized one for reducing stuttering.

Also, the aspect of the anti-voice additionally represents an improvement of known AAF solutions because there is no need for a manual setup phase by an expert. Due to the use of an automated calibration in the generation of an anti-voice, the wearable hearing system can be precisely adjusted to the individual requirements (vocal idiosyncrasies) of the user, without external assistance, thereby improving user-friendliness.

According to one aspect of the present disclosure, the audio processing device can further be configured for determining at least one user-specific vocal feature. Such a user-specific vocal feature can be, for example, a feature, such as gender, age, features of the vocal tract and/or linguistic dialect. The determination preferably takes place in a setup phase, for example on the basis of at least one speech sample.

The audio processing device can further be configured for converting the at least one feature; in particular by using a voice conversion model, which is in particular based on machine learning, when carrying out the voice conversion. The conversion can comprise at least one of:
converting a male to a female voice and/or vice versa;
converting an old to a young voice and/or vice versa;
converting a stretched to a shortened vocal tract and/or vice versa;
converting a wide to a narrow vocal tract and/or vice versa;
converting a linguistic dialect, for example a Northern English dialect to a Southern English dialect;
any combinations thereof.
converting any of the aforementioned features that determine the perception of voice identity (including formant frequencies [timbre], spectral features, temporal characteristics, prosody, articulation and pronunciation, dynamics and loudness, voice quality attributes, non-linguistic sounds), individually or in any combination, to establish a significant or perceptually notable difference from the user's own-voice.

As explanation, it is important to note that the creation of an anti-voice is preferably based on at least one of the above-mentioned determined features of the user. This is why two different anti-voices can be created for two users, who differ in at least one of these features. For example, a male voice of the user can be converted into a female anti-voice, wherein a female voice of the user can be converted into a male anti-voice.

According to one aspect of the present disclosure, the voice conversion for generating an output audio information can further comprise: carrying out a voice anonymization or voice pseudonymization, which are configured for concealing the voice identity of the user. Personally identifiable information in the speech signal can advantageously be suppressed thereby, so that the identity of the speaker is disguised, if possible, but linguistic content, paralinguistic properties, comprehensibility, and naturalness are maintained at the same time.

According to one aspect of the present disclosure, the voice conversion for generating output audio information can further comprise:
capturing information relating to the head position, location and/or movements of the user, in particular by means of a wearable hearing system used by the user; and
using the captured information in order to add spatial audio references during the step of reproduction of the voice-converted output audio information, which are generated by 3D positional audio algorithms for the virtual placement of sound sources at any location in three-dimensional space, such as the “head-related transfer function”, which conveys a hearing impression as if the target voice originates from a predetermined ego-dystonic position within a three-dimensional acoustic space, for example, behind, above, in front of or below the user.

This type of playback can advantageously further intensify the ego-dystonic effect of the target voice.

In other words, the invention encompasses a method for the spatial placement of a target voice within an acoustic field in a three-dimensional space in a manner that is perceptually distinct from natural voice localization, such as positioning the sound source as if it is emanating from a point 3 meters above the user. This approach is suitable for generating or enhancing the generation of an ego-dystonic or anti-voice, as it contradicts the natural proximity effect of perceiving one's own voice as originating “within the skull” [Chang S E, Garnett E O, Etchell A, Chow H M. Functional and Neuroanatomical Bases of Developmental Stuttering: Current Insights. Neuroscientist. 2019 December; 25(6):566-582. doi: 10.1177/1073858418803594. Epub 2018 Sep. 28. PMID: 30264661; PMCID: PMC6486457], thereby challenging the usual physical configuration and sensory expectations associated with self-voice recognition.

In accordance with principles known to those skilled in the art, in spatial audio the sound field dynamically aligns with the user's orientation, diverging from conventional mono or stereo field placement which offers only a static auditory perspective. Spatial audio provides more pronounced auditory cues essential for sensory-based human voice recognition. The application of spatial audio methodologies in generating an ego-dystonic or anti-voice is here disclosed for the first time.

The audio-processing unit of the invention is designed to employ any established technique of spatial audio technology capable of placing a voice within a virtual three-dimensional space, thus fostering an immersive and authentic auditory experience of ego-dystonia. Such technologies are widely utilized across various fields, including virtual reality, gaming, cinematography, music production, and telecommunications. Achieving the virtual placement of a voice at specific, unnatural points in space is feasible through a variety of means known to those skilled in the field. These include, but are not limited to, techniques such as Head-Related Transfer Function (HRTF), Ambisonics, Binaural Processing, and the application of Simulated Distance Cues and Reverb. These methodologies can be employed singularly or in any synergistic combination, as dictated by the specific requirements of the ego-dystonic or anti-voice generation

According to one aspect of the present disclosure, which can also be realized independently of the aspects otherwise disclosed herein, the audio processing device is further configured to continuously change a voice identity of the target voice. This continuous change can be realized in such a way that the auditory impression, particularly the sensory or neural auditory impression, of the target voice remains novel to the user. The continuous change can occur according to a constant rate of change G, at which the target voice gradually changes. The change rate G can correspond to a speed at which a first voice identity completely transitions into a second, perceivably different voice identity. The change rate G can be expressed in percent per second. The change rate G can be determined so that the changing takes place inconspicuously and/or below a perception threshold for acoustic changes. The audio processing device can preferably comprise a program for carrying out the continuous change according to the preferred formula. G can be a static, pre-stored constant. In some embodiments, the audio processing device comprises a suitable program for the interpolation between two voices or between weighted shares of two voices, wherein the weighting can take place according to a linear or non-linear formula.

This has the advantage of counteracting the user's unwanted habituation to the modified voice (and thereby the diminishing effect of the solution), without compromising the listening comfort. The target voice of the user is thereby changed continuously and at preferably constant speed over time in order to always remain novel. The stuttering-reducing effect of the solution disclosed herein can thus also be retained in the case of a regular application (unlimited in time). To keep the changes of the target voice as unnoticeable as possible, in certain embodiments the change rate is chosen so to be below the threshold of the conscious perception of acoustic changes. This takes into account the phenomenon of “change deafness”, which states that changes in acoustic stimuli can go undetected if they occur very slowly [Neuhoff J G, Wayand J, Ndiaye M C, Berkow A B, Bertacchi B R, Benton C A. Slow change deafness. Atten Percept Psychophys. 2015 May; 77(4):1189-99. doi: 10.3758/s13414-015-0871-z. PMID: 25788038]. This hearing-related subtle change method improves the hearing comfort compared to the earlier hearing-related noticeable change method of Kalinowski et al. (2009) [“Adaptation resistant anti-stuttering devices and related methods” of Kalinowski et al. (2009), U.S. Pat. No. 7,591,779 B2 5.1.2.].

The continuous change of the target voice's identity can, for instance, involve implementing appropriate steps of digital speech synthesis, which may include machine learning techniques, to achieve a smooth and seamless transition from one converted voice to another by gradually increasing the proportion of the audio waveform representing the new voice B relative to the audio waveform of the old voice A, resulting in the formation of hybrid voices that blend characteristics of both voices.

Alternatively or additionally, the use of an individualizable voice conversion method can also be employed, adaptable in continuously generating a target voice, for example by means of a linear interpolation between two different speaker profiles stored in a system database, thereby generating hybrid voices in the process that combine features of both voices.

The changes in the voice conversion may not occur simultaneously with the user's speech output, but rather at the beginning of each speaking episode, wherein the degree of change is specified by a certain constant change rate (G), in the same way as already described above.

According to one aspect of the present disclosure, the audio processing device is further configured to perform the following steps: in response to a recognition of a speech activity of the user, dividing sections of the input audio information into sections containing speech and sections without speech, wherein the performance of the voice conversion for generating the output audio information is executed solely on the basis of the sections containing speech. The division can optionally be performed by means of a machine learning model. According to one aspect of the present disclosure, data from a structure-borne sound-related audio sensor system can be observed and pre-classified beforehand in order to distinguish between vocal activity and non-vocal activity of the user, wherein only the part of the input audio information identified as vocal activity is relayed to the speech activity recognition system. Accordingly, compared to conventional AAF solutions, the applicability in everyday speaking situations can be enhanced. In some embodiments, a recognition mechanism, based on advanced methods of machine learning, is utilized in order to reliably differentiate speech of the user from non-verbal utterances of the user as well as from the speech of other persons. The error rate in recognizing non-speech as speech is reduced, along with the distortion of speech from other persons. This recognition technology is used in combination with a sensor system, which records the structure-borne sound when the user speaks, which provides for a reliable recording of the speech of the user even in unfavourable noisy or windy conditions.

According to one aspect of the present disclosure, the audio processing device is further configured to perform the following step: adding a digital water mark, which is imperceptible to the user, into the output audio information, in order to make the target voice identifiable as artificially altered voice, in particular for systems and methods of voice identification. This makes it possible for voice recognition systems to identify the audio signal as artificially created voice, without it being perceptible to the listener.

According to one aspect of the present disclosure, the audio processing device can use data, which is not locally stored, but which is accessible via an external system, such as a cloud system or a wireless network. The demand on the processor performance of the audio processing device, of the wearable hearing device and/or of the voice conversion system can thus be reduced because complex calculation steps can be executed externally.

According to one aspect of the present disclosure, the voice conversion can use voice profiles of target speakers, which are not stored on the below-described components of the system, but which are stored, for example, in a cloud-based manner or in a wireless computer network. The storage capacities of the used device can be multiplied therewith, so that users have a greater flexibility in searching for a suitable target voice. This can improve the performance results because it becomes more likely that a suitable ego-dystonic target voice (or anti-voice) can be selected for a certain user when a wide range of options is available.

Various designs are provided without limitation for the audio processing device disclosed herein (also referred to as audio processing system), for example:
a separate computer device, which serves as “client” for the wearable hearing device (see below), for example a mobile electronic user device, such as mobile telephone or smartphone, respectively, a hand-held device (smartwatch), a tablet computer, a laptop computer, or any portable computer device, which is comparable regarding functionality and connectivity. The separate device can use a wireless data transfer method for transferring data to the hearing system, including, but not limited to Bluetooth, Bluetooth “low energy”, IEEE 802.11, Zigbee, Wi-Fi, ultra-wideband, magneto-inductive near field communication, optical signals, such as infrared or another method for the wireless data transfer, including each combination of those mentioned.
A (server) computer or (server) computer system, which is located on a wireless computer network, the Internet or a cloud-based system. The (server) computer or the (server) computer system can be connected to the wearable hearing device (see below) via an interface for the wireless data transfer, as described above.

The present invention may encompass advanced wireless data transfer technologies that integrate and build upon the foundation laid by 5G networks. These technologies may include, but are not limited to, enhanced mobile broadband (eMBB), ultra-reliable low-latency communications (URLLC), and massive machine-type communications (mMTC), leveraging key technological advancements such as multiple-input multiple-output (MIMO), nonorthogonal multiple access (NOMA), energy harvesting, and millimeter-wave (mmWave) communications.

Further, for the wireless data transfer the invention also anticipates the evolution of wireless data transfer beyond 5G (B5G) and sixth-generation (6G) networks. These future-generation networks aim to significantly advance the performance capabilities by providing ultralow latency, ultrahigh reliability, global coverage, and massive connectivity, enriched with the integration of machine-learning techniques. The B5G/6G networks may incorporate novel technologies such as massive MIMO, hybrid satellite terrestrial relays, and IoT-based home automation. Additionally, the invention may include the transmission of data via terahertz (THz) wireless communication, operating in the 0.1-10 THz frequency range, as a promising frontier for next-generation wireless communication.

A further aspect of the present invention relates to a wearable hearing device (also referred to as wireless hearing system or wearable hearing system). The hearing device can comprise an audio sensor device for capturing input audio information, which comprises at least one verbal utterance in a natural voice of a user. The hearing device can comprise means for transferring the input audio information to an audio processing device and for receiving voice-converted output audio information from the audio processing device in an ego-dystonic target voice, in that the at least one verbal utterance has been converted as if the same speech content was produced by a different speaker. The hearing device can comprise an audio output device for reproducing, in particular binaural reproducing, the voice-converted output audio information to the user, in particular at least approximately in real time as feedback to the speaking of the user. The audio processing device is thereby preferably an audio processing device according to any one of the aspects disclosed herein.

Different embodiments are provided for the wearable hearing device, for example without limitation:
Wireless headphones (true wireless) with wireless transfer technology, including, but not limited to “in-ear headphones” as well as “earbuds”, “in-the-ear” (ITE), “on-ear headphones”, “over-ear headphones”, “bone conduction headphones”.
Wireless hearing aid devices, including, but not limited to devices placed behind the ear (“behind-the-ear”, BTE), devices placed in the ear (“in-the-ear, ITE”), devices partially placed in the auditory canal (“in-the-canal, ITC”), device receivers placed in the auditory canal (“receiver-in-canal, RIC”), devices placed completely in the auditory canal (“completely in-the-canal, CIC”) as well as cochlea implants.
A head mounted device, which can process audio and image information, including, but not limited to HMDs, augmented reality glasses and smart glasses.
So-called Metaverse Technologies, including, but not limited to Assisted Reality Devices, Virtual Reality (VR) Headsets, Augmented Reality (AR) Glasses.
A brain implant, which is suitable to receive computer-readable data and to modify hearing-related neurological events of the user.

According to one aspect of the present disclosure, the audio sensor device of the wearable hearing device can comprise one or several airborne-sound microphones, including, but not limited to electret condenser microphones, MEMS microphones, binaural microphones, omni-directional microphones and beamforming-supporting microphones as well as other airborne-sound microphones, which are suitable to transfer speech-related airborne sound.

According to one aspect of the present disclosure, the audio sensor device of the wearable hearing device can comprise one or several structure-borne sound microphones, including, but not limited to piezoelectric or piezoceramic acceleration sensors, differential pressure sensor, MEMS acceleration sensors and other sensors, which are suitable to transfer speech-related structure-borne sound.

A further aspect of the present invention relates to a voice conversion system. The voice conversion system can comprise an audio processing device according to the present disclosure and a wearable hearing device according to the present disclosure.

In one possible embodiment, the voice conversion system is a combination of (at least) two separate devices, namely the wearable hearing device and the audio processing device. Any combinations of the embodiments disclosed further above can be provided thereby, for example, the wearable hearing device can be incorporated into headphones and the audio processing device can be incorporated into a smartphone or hosted on a server.

In another embodiment, the voice conversion system is an integrated system, where both the wearable hearing device and the audio processing system are combined into a single unit, preferably in a common housing, even more preferably in a wearable common device. The integration of the wearable hearing device as well as of the audio processing device in headphones is a non-limiting example.

According to one aspect of the present disclosure, the voice conversion system can comprise a graphical user interface (abbreviation: GUI), which makes it possible for the user to configure the device and to adapt the steps of the voice conversion as well as audio reproduction individually to improve the hearing comfort. Via the GUI, the user can adapt certain settings with regard to the voice conversion or the output of the voice-converted voice, such as, e.g., set the volume to the desired hearing comfort. This provides for a highly advantageous measure of adaptability of the system, so that the user can comfortably handle the characteristics of the selected ego-dystonic target voice.

A further aspect of the present invention relates to a voice conversion method. The method can be computer-implemented. The method can serve the purpose of improving the flow of speech in the case of fluency disorders; in particular in the case of stuttering. The method can be carried out by an audio processing device; in particular by a mobile electronic user device, by an audio processing device integrated into a wearable hearing system, or by a server. The method comprises one or several of the following steps: receiving input audio information from an audio sensor device, which comprises at least one verbal utterance in a natural voice of a user; carrying out a voice conversion for generating output audio information in an ego-dystonic target voice, in that the at least one verbal utterance is converted as if the same speech content was produced by a different speaker; prompting a reproduction, in particular a binaural reproduction, of the voice-converted output audio information to the user at least approximately in real time as feedback to the speaking of the user. The method can further comprise steps, which correspond to the function of the audio processing device according to any one of the aspects described further above or elsewhere in the present disclosure.

The method is preferably not intended for the treatment or prevention of diseases. It is in particular not to be considered as therapeutic method in terms of a medical measure for diagnosing, preventing, treating or healing diseases in humans or in animals. The method could additionally not be performed by a doctor or healthcare professional because the performance preferably takes place by using the technical device described herein and preferably does not require medical supervision or expertise. In preferred embodiments, the method according to the invention can be used in the private, professional and personal field, e.g. at home with the family, or in the social or professional environment. The method according to the invention is preferably not used in a clinical environment for the therapeutic treatment or healing of a disease or disorders of bodily functions. It is generally accepted, for example, that methods, which are applied in the private, professional and personal field of a person are not considered to be therapeutic methods. It is important to point out that the World Health Organization (2023) does not classify developmental stuttering as disease but as “stereotypic movement disorder” [“F98 Andere Verhaltens-und emotionale Stdrungen mit Beginn in der Kindheit und Jugend. In Internationale statistische Klassifikation der Krankheiten und verwandter Gesundheitsprobleme 10 [English translation: “Other behavioral and emotional disorders with onset usually occurring in childhood and adolescence 10′]. revision. Accessed: https://www.dimdi.de/static/de/klassifikationen/icd/icd-10-gm/kode-suche/htmlgm2023/block-f90-f98.htm#F9”8”].

The method corresponds to a prosthesis-like correcting device, which, similarly to a pair of glasses, improves a non-pathological impairment of the user for the duration of the application. The method accordingly has no healing effect (no elimination of the cause) but is limited to the immediate reduction of stuttering symptoms, as long as the method is applied.

Carry-over effects, contraindications, risks or interactions, as they are typical for therapeutic or medical methods, can be plausibly ruled out.

Within the context of the overall disclosure of the present invention, it shall be noted that the herein disclosed subject-matter related to medical treatments reflect preferred subject-matter. In contrast to medical treatments, however, the herein disclosed training methods or non-medical uses of the invention, for instance, are distinct from medical treatments and must be placed into another context. That is, due to the herein provided training methods positive “carry-over effects” may well be present for increasing speech fluency, but these do not reflect carry-over effects in the medical sense.

There is no physical intervention into the body, the method is based solely on an acoustic intervention to influence the sensory or neural recognition of one's own voice during speech. The influence on the neuronal mechanism of self-voice recognition described herein does not represent an invasive procedure or invasive intervention into the functioning of the user's body and does not involve any health risk.

As a whole, it can be concluded therefrom that the method described here is not to be considered to be a therapeutic method.

A further aspect of the present disclosure relates to a computer program or a computer-readable storage medium, on which such a computer program is stored. The computer program can comprise commands, which, when executing the program by a computer, prompt the latter to execute any one of the methods or method aspects disclosed herein, respectively. This preferably includes the performance of all steps, for which the audio processing device, the wearable hearing device or the voice conversion system are configured.

According to one aspect of the present disclosure, the method or the above-described computer program, respectively, can be integrated into commercially available “true wireless” headphones, such as the Apple AirPods. Additional examples, not limited to these, include the Sony WF-1000XM4, Bose QuietComfort Earbuds, Samsung Galaxy Buds Pro, Sennheiser Momentum True Wireless 2, and Google Pixel Buds. This provides for a discrete application because they cannot be differentiated from conventional hearing aids. This means, this provides for a discrete application because they cannot be differentiated from commercially available headphones, such as “true wireless” headphones. This reduces the described risk of social stigmatization compared to prior hearing aid-like anti-stuttering devices; especially for users in childhood and adolescence. A further advantage of using stuttering-reducing technologies in commercially available “true wireless” headphones is the synergy they offer with other speech-based software applications, such as video telephony and digital speech assistance, and it is no longer necessary to use several systems, which are operated separately (for example an anti-stuttering device and a smartphone).

As already mentioned further above, the aspects disclosed herein can be realized in any combination and also individually, independently of one another. This relates in particular, but not exclusively, to the aspects of the ego-dystonic target voice, the anti-voice and the continuous change of the target voice.

### BRIEF DESCRIPTION OF THE DRAWINGS

Preferred embodiments of the present disclosure will be described below with reference to the following figures:

FIG. 1: shows a schematic illustration of a wearable voice conversion system according to an exemplary embodiment

FIG. 2: shows a flow chart of a voice conversion method according to an exemplary embodiment

### DETAILED DESCRIPTION

Currently preferred exemplary embodiments will be disclosed below, the object of which is a computer-implemented method for the (immediate) reduction of stuttering. By reducing stuttering, the user's speech performance is enhanced. The features of the method apply mutatis mutandis to all aspects of the disclosure; in particular to the wearable hearing device, the voice conversion system, the data processing device and the computer program.

Technologies and methods of voice conversion are used in some exemplary embodiments in order to generate an ego-dystonic voice identity, which, when reproduced as feedback to the user's speech, is sensorially perceived as “another voice”. In some exemplary embodiments, the method can be personalized in order to generate an anti-voice, which systematically maximizes the self-dissimilarity of the converted voice from the natural voice of the user. Thus, users do not have to be assigned a random ego-dystonic target voice that is too similar to their own voice, but one that is known to be distinctly different from the user's voice. In other words, the personalization ensures that the source and target voices have a sufficient degree of perceptual dissimilarity, where ‘sufficient’ refers to the degree of dissimilarity at which a target voice is being recognized as a “foreign voice” on a sensorial/neural level. This prevents an unwanted activation of the auditory feedback loop of the user, which can obstruct the fluency. To prevent adaptation effects and to maintain the speech-fluency enhancing effect even in the case of a regular application, the converted voice changes continuously in some exemplary embodiments, wherein the change gradually proceeds so slowly over time that it remains perceptually inconspicuous.

In some exemplary embodiments, the utilized wearable technical system comprises two functional components: a wireless hearing system (also referred to as wearable hearing device), which detects the speech of the user and outputs the converted speech to the user, as well as an audio processing system (also referred to as audio processing device), which executes the computer-based steps of the voice conversion in real time or approximately real time.

The term “almost real time” or “approx. real time” used here preferably refers to a delay between the reception of unprocessed data and the output of processed data of less than 50 ms, preferably less than 30 ms, even more preferably less than 20 ms. The said delay-time of less than 50 ms broadly corresponds to empirical evidence on the so-called “fusion echo threshold”, i.e. the delay at which the perception of one fused sound becomes two separate sounds, as has been found for speech signals (Ruth Y. Litovsky, H. Steven Colburn, William A. Yost, Sandra J. Guzman; The precedence effect. J. Acoust. Soc. Am. 1 Oct. 1999; 106 (4): 1633-1654. https://doi.org/10.1121/1.427914).

In another aspect, the term “almost real time” or “approx. real time” used herein refers to a delay between the reception of unprocessed data (speech) and the output of processed data (ego-dystonic or anti-voice) of less than 160 ms. This delay threshold is based on research regarding the temporal window used by the human central auditory system to integrate successive auditory inputs into unified auditory event percepts [Yabe H, Tervaniemi M, Sinkkonen J, Huotilainen M, Ilmoniemi R J, Näätänen R. Temporal window of integration of auditory information in the human brain. Psychophysiology. 1998 September; 35(5):615-9. doi: 10.1017/s0048577298000183. PMID: 9715105]. This research indicates that when feedback of one's own speech is delayed by no more than 160 milliseconds, it is still perceived as a coherent auditory event that occurs in real-time.

In another aspect, the term “almost real time” or “approx. real time” used herein refers to a delay between the reception of unprocessed data (speech) and the output of processed data (ego-dystonic or anti-voice) of less than 160 ms, preferably less than 150 ms, more preferably less than 140 ms, more preferably less than 130 ms, even more preferably less than 120 ms, even more preferably less than 110 ms, even more preferably less than 100 ms, even more preferably less than 90 ms, even more preferably less than 80 ms, even more preferably less than 70 ms, most preferred less than 60 ms.

Different aspects and components are described below on the basis of exemplary embodiments.

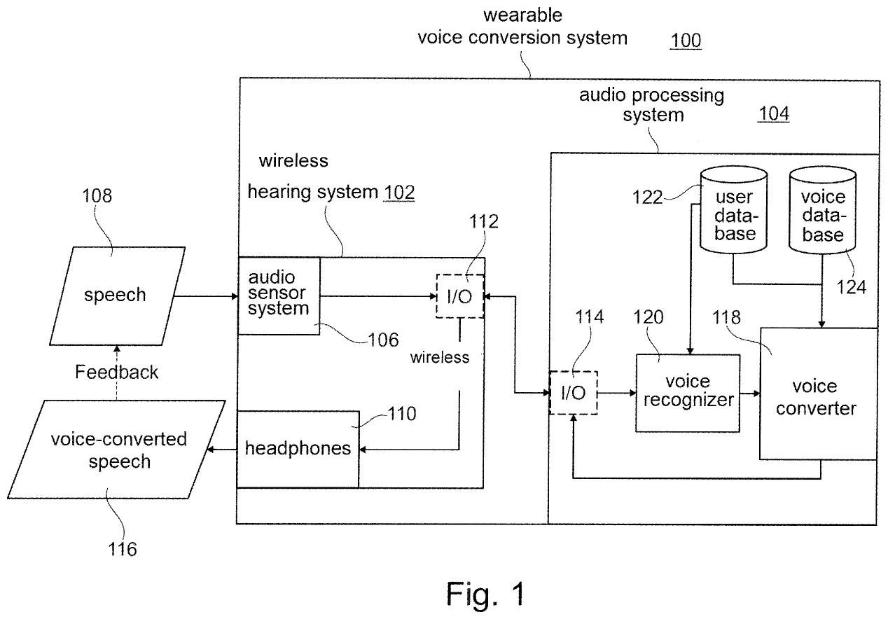

FIG. 1 shows a schematic illustration of an exemplary embodiment of a wearable voice conversion system 100, in which the methods disclosed here and/or the preferred audio processing steps can be applied. It is important to note that the illustrated embodiment as a wearable system is only one possible embodiment and that the basic principles disclosed herein can equally also be realized in non-wearable systems (for example comprising a server as audio processing system). The wearable voice conversion system 100 consists of a wearable hearing system (also referred to as wearable hearing device) 102 and an audio processing system 104. The audio processing system 104 can either be a separate device or part of the wearable hearing system 120.

Different wearable hearing systems 102 can be used, which have at least one of the following features:
a compact form, which can be worn on the ear, in the ear or in the vicinity of the ear.
An audio sensor system 106 (also referred to as “audio sensor device”), which is geared towards the detection of speech 108 of the user.
Headphones 110 for the binaural (concerning both, the left and right ear) reproduction of an audio source.
An interface 112 for the wireless data exchange.
Components, such as battery, memory, processor and converter, as are typical for current hearing systems. The expert can adapt components of this type for the use in the wearable hearing system described here. They are thus not illustrated in more detail in the figures.

Examples for wearable hearing systems 102, which are suitable for the use of the method, are mentioned below:
in a typical embodiment, wireless headphones are used, also referred to as “true wireless”, which use a wireless technology in order to transfer data between an audio source and the headphones. Examples for this are commercially available consumer headphones, which are known for the user-friendly coupling to a mobile telephone, such as the Apple AirPods, Google Pixel Buds or Samsung Galaxy Buds Plus. Different types can be used. This includes: “in-ear headphones” as well as “earbuds”, “in-the-ear” headphones, “on-ear” headphones, “over-ear” headphones, bone conduction headphones located “behind the ear”.

Such known headphones, optionally with appropriate software or hardware modifications, can be utilized to wirelessly or via cable send input audio information to an audio processing device, receive output audio information from the audio processing device and reproduce the output audio information to the user. Details relating to technical features and variations of wireless headphones, which are suitable for the method described here, can be gathered from the following reference [“The International Electrotechnical Commission (2020). Sound system equipment—Part 7: Headphones and earphones (IEC 60268-7:2010+A1:2020). Retrieved from https://webstore.iec.ch/publication/67633”]. The content of this reference is incorporated by reference in its entirety, as though it were fully set forth herein.

In another embodiment, wireless hearing support devices, also referred to as hearing aid, hearing implants or hearing devices, are used. Examples for such devices are cochlea implants, devices placed behind the ear (“behind-the-ear”), devices partially placed in the auditory canal (“in-the-canal”), device receivers placed in the auditory canal (“receiver-in-canal”) as well as devices placed completely in the auditory canal (“completely in-the-canal”). In selected embodiments, a device according to the invention can be connected to a an already existing hearing device, hearing implant or hearing aid of the user, or can be connected thereto, respectively. In embodiments, this connection can take place physically (e.g. via cables or adapters) or in a cordless/wireless manner, e.g. via radio, for example by means of Bluetooth® or infrared connection or any other connection described herein. This connection of the device according to the invention to an already available hearing device, hearing implant or hearing aid preferably does not comprise or require a surgical or physical intervention at the user and preferably does not comprise a significant health risk.

Details relating to technical features and variations of hearing aids, which are suitable for the method described herein, can be gathered from the following two references [“The International Electrotechnical Commission (2022). Electroacoustics—Hearing aids—Part 0: Measurement of the performance characteristics of hearing aids (IEC 60118-0:2022). Retrieved from https://webstore.iec.ch/publication/62974”; “The International Electrotechnical Commission (2022). Electroacoustics—Hearing aids—Part 16: Definition and verification of hearing aid features (IEC 60118-16:2022). Retrieved from https://webstore.iec.ch/publication/63325. The content of this reference is incorporated by reference in its entirety, as though it were fully set forth herein.

In yet other embodiments, the method uses a device mounted to the head, also referred to as “head-mounted device” (HMD), “augmented-reality glasses”, “smart glasses” or “virtual reality glasses”, which can be processed as audio as well as image information in real time. The “HoloLens 2” from the Microsoft Corporation, Redmond, Washington, United States, is an example for a suitable device, which can record the voice of the user as well as reproduce audio.

The wearable hearing system 102 can include devices that are similar in type or related.

In some exemplary embodiments, to use the above-mentioned hearing systems 102, the method described herein can be implemented into a third-party provider application or interface, respectively. There is, for example, special control software—such as “Sonios.ai”—which is designed to allow independent software developers to reprogram hearing systems, such as “earbuds”.

The described wearable hearing system 102 detects the speech input 108 of the user with the help of an audio sensor system 106. Audio sensor system 106 is understood herein as a unit, which detects the speech signals 108 produced by the user and converts them into an electrical or digital audio signal representation. This unit can consist of one or several components (with regard to microphones or sensor types), as described below:
in one embodiment, airborne-sound microphones are utilized to detect the user's speech 108, as is common for the electroacoustic transfer of speech. Different types and directional characteristics of microphones can be employed, for example electret condenser microphones, microphone system microphones (“micro electro-mechanical systems microphones”, abbreviation: “MEMS”), binaural microphones, omnidirectional microphones as well as microphones supporting the beamforming technology. They typically operate within a range of 50-15.000 Hz.

In a further embodiment, structure-borne sound microphones are used to detect the user's speech 108, which are also known as motion sensors or accelerometers in order to create an audio signal representation. Piezoelectric acceleration sensors, piezoceramic acceleration sensors, differential pressure sensors, microsystem acceleration sensors (“micro electro-mechanical systems microphones”, abbreviation “MEMS”) and other sensors, which are geared towards picking up the sound, which is transferred via the bone conduction of the user, are examples for this. The consideration of structure-borne sound offers important advantages compared to a system, which exclusively uses the airborne sound. This enables to reliably recognize speech sequences even under difficult conditions, such as, for example, loud background noise or when wearing a face mask. The risk of an incorrect recognition, for example speech being mistaken for noise or noise being mistaken for speech, can also be significantly reduced. They typically operate within a range below 50 Hz. Details relating to the use of structure-borne sound sensors for detecting the voice of the user in a wearable hearing system can be gathered from the literature:
Pertilä, P., Fagerlund, E., Huttunen, A., & Myllylä, V. (2021). Online Own Voice Detection for a Multi-Channel Multi-Sensor In-Ear Device. IEEE Sensors Journal, 21, 27686-27697;
Burns & Jensen, Method and apparatus for own-voice sensing in a hearing assistance device, US patent application 2021/0120347 A1;
Sorin et al. (2021), “Automatic speech recognition triggering system”, U.S. Pat. No. 11,102,568 B2.

Details relating to technical features and variations of microphones for headphones, which are suitable for the method described herein, can be gathered from the following reference [“The International Electrotechnical Commission (2020). Sound system equipment—Part 4: Microphones (IEC 60268-4:2018 RLV). Retrieved from https://webstore.iec.ch/publication/63860” ].

In a preferred embodiment, the speech detection is carried out in a multi-sensory manner, combining both, structure-borne sound-based and airborne sound-based sensor systems to enhance speech detection. In such a multi-sensory approach, the signals of sound-based and non-sound-based microphones can be combined to form a common audio signal representation. This can be attained by means of filtering, such as the use of low-pass and high-pass filters, as well as by means of fusion and can be controlled by means of algorithms. In another embodiment, both signals remain separated. The audio signal representation created by means of the sensor unit 106, which is relayed to the audio processing system 104, can thus either be single-channel (consisting of one data stream) or multi-channel (consisting of several data streams).

The audio signal representation is relayed from the sensor unit 106 of the hearing system 102 to the digital audio processing system 104, which carries out the computer-based steps for generating an ego-dystonic voice.

The digital audio processing system 104 can be a separate computer device, which serves as “client” for the mobile hearing system 102, for example a mobile telephone, a handheld device (smartwatch), a tablet computer, a laptop computer, or any portable electronic device, which is comparable with regard to type and functionality. The audio processing system 104 can be configured in a computer network or a cloud-based system in order to serve as “client”. In a special embodiment, this network is the Internet.

If the audio processing system 104 is a separate device, the data exchange is carried out via an interface 114 for the wireless data exchange. For this purpose, each known wireless method can be used to transfer data, such as, e.g., Bluetooth, Bluetooth “low energy”, IEEE 802.11, Zigbee, Wi-Fi or ultra-wideband. Further wireless means and methods for the wireless transfer of data are known to the person of skill in the art. To achieve minimal latency in generating the voice conversion, the data exchange can be realized via the low-latency-causing near-field magnetic induction communication (“NFMI”) technology or via optical signals, such as infrared, as described in Silvast et al., 2022 [“Optical audio transmission from source device to wireless earphones”, U.S. Pat. No. 11,234,078 B1]. The audio processing can thus essentially occur in real time. The data exchange can be established only when receiving audio data in order to decrease the energy demand of the system. Various forms of connection can be used. The above-mentioned methods of wireless data exchange can be used simultaneously or alternately.

In a further embodiment, the audio processing system 104 is an integrated part of the described hearing system 102. For example, commercially available in-ear headphones have powerful, programmable processors. This means that the discrete elements shown in the images only serve illustrative purposes. In practice, the entire digital audio signal processing can occur within a stand-alone device 100. This can accelerate the processing of audio data since the device is not subject to the latency that occurs in wireless networks.

The audio processing system 104 comprises a memory. The memory can be embedded into the processing unit 104 and/or can be used in a memory unit connected to the processing unit 104.

The audio signal representation produced by the sensor unit 106 can be pre-processed by the audio processing system 104 in different steps, as it is typical for the pre-processing of speech signals. For example, by means of sampling rate change, normalization, noise suppression, intelligibility enhancement, Fourier transformation and spectrogram analysis. An overview of typical methods of digital speech signal improvement can be gathered from the pertinent technical literature [Sen S. Dutta A. & Dey N. (2019). Audio processing and speech recognition: concepts techniques and research overviews. Springer. https://doi.org/10.1007/978-981-13-6098-5]. It should be noted that the present disclosure pertains not only to the calculation method for converting a user's speech data into a foreign voice, but also to the inventive application of this method in devices, systems and methods for improving a user's speech performance.

The converted voice is relayed to the wearable hearing system 102.

If the wearable hearing system 102 is a separate device, a wireless data transfer takes place, as described. A wearable hearing system 102 as separate device preferably means that the wearable hearing system 102 entails cooperation with one or several processors, which are not fully integrated into the wearable hearing system 102.

The acoustic reproduction of the converted speech input 116 to the left and right ear of the user takes place via the two headphones 110 (typically electroacoustic transducers) integrated in the wearable hearing system 102.

In preferred exemplary embodiments, the sound reproduction takes place as part of the AAF paradigm as immediate feedback to the speaking of the user, with as little delay as possible in real time.

In preferred exemplary embodiments, the reproduction is implemented as binaural feedback, which, compared to a monoaural feedback, increases the expected stuttering reduction by approx. 25% [Stuart, Andrew & Kalinowski, Joseph & Rastatter, Michael. (1997). Effect of monaural and binaural altered auditory feedback on stuttering frequency. The Journal of the Acoustical Society of America. 101. 3806-9. 10.1121/1.418387].

In preferred embodiments, playback of the converted voice 116 into the external environment does not occur, in order to prevent misuse through the use of a “fake voice”. In other words, in preferred embodiments, the target voice created by means of the voice conversion is intended only for the self-perception of the user and is not used for the reproduction to the environment or others.

In special embodiments, the sound reproduction takes place in a format, which is suitable for the reproduction of a voice in the three-dimensional sound field, e.g., in spatial stereo with dynamic tracking of the position, location and movements of the head (“head tracking”), as described below.

The audio signal representation created by the sensor unit 106 can be directed through a digital-to-analogue converter (DAC) to be supplied to the audio processing system 104. After the speech input has been converted by means of the audio processing system 104, the audio signal representation can be converted back into its analogue form again using the digital-to-analogue converter (DAC). These converters can be components of either the hearing system 102 or of the audio processing system 104.

The voice converter 118 is preferably a computer-based application, capable of changing the user's voice to sound like the voice of another person. The speech content of the user remains unchanged thereby, while only the speaker-dependent acoustic features are modified in preferred embodiments. The voice converter 118 performs the voice conversion in real time or almost in real time in order to play back the target voice to the user as speech-related feedback for the stuttering reduction.

For this purpose, the voice converter 118 can use technologies and methods of the voice conversion, as they are described in the present disclosure.

The purpose of the voice converter 118 is to create an identity-shifted feedback of the user's voice to represent the voice of another person. Through the use of the voice converter 118, an auditory impression is created for the user, wherein their own voice is perceived in a sensory or neural manner as “ego-dystonic”, meaning it is perceived as different from their own, resembling that of another person.

In one exemplary embodiment, the voice converter 118 uses technologies and methods, which are known to a person skilled in the art as voice conversion. This includes alternative, less frequently used terms, such as speaker adaptation, speaker voice conversion, voice cloning or voice-to-voice conversion.

Specifically, it utilizes machine learning technologies and methods, including the following:
Deep neural network (DNN), as described in [Ling-hui Chen, Zhen-hua Ling, Li-juan Liu, and Li-rong Dai, “Voice Conversion Using Deep Neural Networks With Layer-Wise Generative Training,” IEEE Transactions on Audio, Speech and Language Processing, vol. 22, no. 12, pp. 1859-1872, 2014.],
Recurrent neural network (RNN), as described in [Nakashika, T., Takiguchi, T., Ariki, Y., 2014. High-order sequence modeling using speaker-dependent recurrent temporal restricted boltzmann machines for voice conversion. In: Fifteenth Annual Conference of the International Speech Communication Association.],
Generative adversarial network (GAN), as described in [Sisman, B., Zhang, M., Sakti, S., Li, H., Nakamura, S., 2018. Adaptive wavenet vocoder for residual compensation in gan-based voice conversion. In: 2018 IEEE Spoken Language Technology Workshop (SLT). IEEE, pp. 282-289.]
Sequence-to-sequence mapping networks, as described in [Zhang, J.-X., Ling, Z.-H., Liu, L.-J., Jiang, Y., Dai, L.-R., 2019b. Sequence-to-sequence acoustic modeling for voice conversion. IEEE/ACM Trans. Audio Speech Lang. Process. 27 (3), 631-644.]

An exemplary overview of specific models of machine learning for the voice conversion can be gathered from the below-mentioned technical publication: [Zhao, Y., Huang, W.-C., Tian, X., Yamagishi, J., Das, R. K., Kinnunen, T., Ling, Z., Toda, T., 2020. Voice conversion challenge 2020: Intra-lingual semi-parallel and cross-lingual voice conversion. arXiv preprint arXiv:2008.12527.]

The voice converter 118 can in particular utilize:
technologies and methods of machine learning (hereinafter referred to as “methods”), in order to imitate voices of certain speakers, with which it was trained. In the case of these methods, the target voices originate from actually existing persons.
Methods for artificially generating voices of fictitious (actually non-existing) speakers, with which the respective machine model was not trained beforehand. In the case of these methods, hybrid target voices can be created, which combine voice characteristics of two different speakers into one target voice.
Methods for a language-dependent (intralingual) voice conversion, wherein the speaker identity is converted only between source speakers and target speakers of the same language.
Methods for a cross-language (interlingual) voice conversion, wherein the speaker identity is also converted between source speakers and target speakers, who speak different languages.
Methods for a gender-dependent (intra-gender) voice conversion, wherein the speaker identity is converted only between source speakers and target speakers of the same gender.
Methods for a gender-independent (inter-gender) voice conversion, in the case of which the speaker identity is also converted between source speakers and target speakers of the respective other gender.

Details of these methods are described in the aforementioned technical literature and are known to a person skilled in the art, which is why a detailed description is omitted here.

In certain embodiments of the invention, the voice converter 118 employs a generative method of voice conversion, which is geared towards generating new speaker voices, i.e. not used for the machine learning. Thereby, the conversion is not confined to the imitation of a specific speaker voice [A, B, C [ . . . ]), but allows for the individual customization of a speaker voice to a “fictitious” speaker voice, for example hybrid voices, which combine characteristic acoustic features of two different speaker voices (AB, BC, CA [ . . . ]). Such a method, which is based on principles of machine learning, has been described in the technical literature [Ho, T. V., & Akagi, M. (2021). Cross-Lingual Voice Conversion With Controllable Speaker Individuality Using Variational Autoencoder and Star Generative Adversarial Network. IEEE Access, 9, 47503-47515.]

Machine learning (i.e. the training of a specific model) can be conducted in various ways, as known from the technical literature or applications in voice conversion, for example:
supervised methods of machine learning. These typically utilize “parallel speech data”, where utterances (audio samples) from two speakers with the same linguistic content and in the same language are present. For this purpose, audio samples of verbal utterances with a length of 2 to 60 seconds and from at least 10 different speakers may be recoded, for example. Each speaker records each utterance in the same language and with identical content. In the case of 10 speakers and 1000 utterances, a total of 10,000 audio samples are recorded. This corpus of “parallel speech data” is then employed in the training of a specific model for the machine learning.

Non-supervised methods of machine learning. These typically use “non-parallel speech data”, where utterances from two speakers are present, which differ in linguistic content or the language. For this purpose, voice data already available from public databases can be used, for example:
“LibriSpeech” [Panayotov V, Chen G, Povey D, Khudanpur S (2015) Librispeech: an ASR corpus based on public domain audio books. In: IEEE International Conference on Acoustics, Speech and Signal Processing (ICASSP), South Brisbane];
“LibriTTS” [H. Zen, V. Dang, R. Clark, Y. Zhang, R. J. Weiss, Y. Jia, Z. Chen, and Y. Wu, “Libritts: A corpus derived from librispeech for text-to-speech,” arXiv preprint arXiv:1904.02882, 2019.];
“Voice Conversion Challenge (VCC) database 2020” [Zhao, Y., Huang, W.-C., Tian, X., Yamagishi, J., Das, R. K., Kinnunen, T., Ling, Z., Toda, T., 2020. Voice conversion challenge 2020: Intra-lingual semi-parallel and cross-lingual voice conversion. arXiv preprint arXiv:2008.12527.];
“VCTK database” [Veaux C, Yamagishi J, MacDonald K (2019) CSTR VCTK Corpus: English multi-speaker Corpus for CSTR voice cloning toolkit. The Centre for Speech Technology Research (CSTR), University of Edinburgh].

An overview of all databases, which are currently suitable for the machine learning of a voice conversion model, as well as details relating to the use thereof, can be found in the technical literature and are known to those skilled in the art, for example:
[Dagar, D., Vishwakarma, D. K. A literature review and perspectives in deepfakes: generation, detection, and applications. Int J Multimed Info Retr 11, 219-289 (2022). https://doi.org/10.1007/s13735-022-00241-w]
[Zhou, K., Sisman, B., Liu, R., & Li, H. (2021). Emotional Voice Conversion: Theory, Databases and ESD. Speech Commun., 137, 1-18.]
[Zhao, Y., Huang, W.-C., Tian, X., Yamagishi, J., Das, R. K., Kinnunen, T., Ling, Z., Toda, T., 2020. Voice conversion challenge 2020: Intra-lingual semi-parallel and cross-lingual voice conversion. arXiv preprint arXiv:2008.12527.]
[Zhang, Mingyang & Sisman, Berrak & Zhao, Li & Li, Haizhou. (2020). DeepConversion: Voice conversion with limited parallel training data. Speech Communication. 122. 10.1016/1j.specom.2020.05.004.]

A voice conversion method according to an exemplary embodiment will be described below. The method comprises the following steps: speech input (step 1), voice conversion (step 2), output (step 3). It should be noted that the features of each step can be selected independently of the features of other steps, except in cases, in which the features are incompatible. Such cases are known to those with ordinary skill in the art.

In step 1 (speech input), the sensor unit 106 creates an audio signal representation of the speech of the user, which serves as the input for the voice converter 118. In step 2 (voice conversion), the voice converter 118 modifies the voice of the user in order to make it sound like the voice of another speaker, in that methods and technologies of the voice conversion disclosed herein are used, either in real time or near real time. The result of the voice conversion is a continuous audio signal waveform, which corresponds to the duration of the original speech input. In step 3 (output), the modified audio signal waveform is transmitted to the mobile hearing system 102 for the user. The described steps are executed in real time or near real time, continuing until the speaking episode has ended or until the speech recognizer 120 classifies the segment of the signal as “non-speech”.

The voice conversion step (step 2) can itself be realized, in turn, as a three-step process, for example as follows:
feature extraction: the audio signal representation is analysed step-by-step and is decomposed into speaker-unspecific acoustic features of the linguistic content as well as speaker-specific acoustic features, such as, for example, formants, fundamental frequency (F0), intonation, intensity and duration. For this analysis, spectral features, such as Mel cepstral coefficients (abbreviation: MCEP), linear predictive cepstral coefficients (abbreviation: LPCC), and/or line spectral frequencies (abbreviation: LSF) can be determined. This step may also encompass the assessment of voice quality through various metrics, which include, but are not limited to, jitter (representing frequency variation), shimmer (indicating amplitude variation), and the Harmonics-to-Noise Ratio (HNR), thereby providing a comprehensive analysis of the voice quality. The process may use a technique called speech analysis or feature extraction. This stage involves the extraction of a range of acoustic features from the source voice, including but not limited to pitch, timbre, duration, and formant frequencies. These features are critical in defining the unique aspects of the voice that need to be converted. These analysed an/or extracted features are instrumental in delineating the unique aspects of the source voice, thereby forming the essential basis for the subsequent conversion process.
Feature assignment: these speaker-specific features are assigned to the features of the target voice. The assignment is controlled by means of a conversion function F(x), which was preferably learned by the model during the training phase. In other words, during this conversion step, the extracted features from the source voice are transformed to match the target voice. This involves altering the characteristics of the source voice to approximate those of the target voice. Well-documented methods such as Gaussian Mixture Models (GMMs) or Deep Neural Networks (DNNs) can be utilized for the transformation of the extracted features to align with those of the target voice. This may involve well-understood procedures like frame alignment using algorithms such as Dynamic Time Warping (DTW), and the transformation of features including pitch scaling, formant shifting, and timbre adjustment. This crucial step is governed by a conversion function, typically denoted as F(x), which may be derived and refined during the model's training phase. The function F(x) effectively maps the features from the user's (source) voice to the ego-dystonic (target) voice, ensuring that the resulting output closely resembles the target in terms of its unique vocal attributes.
Speech synthesis: the inverse process for the feature extraction, the speech synthesis, converts the modified parameters back into audible speech signals, which sound like the desired target voice. A vocoder, which is based on neural networks, can be used for this purpose, for example. In other words, the final step is to synthesize the transformed features back into an audible voice, effectively generating the target voice from the modified source features. Techniques known in the art, such as the use of vocoders like STRAIGHT or WORLD, or alternative speech synthesis technologies may be implemented for this purpose. Parameters like pitch contour and spectral envelope may be fed into the vocoder. The synthesis process reconstructs a natural-sounding voice from the transformed features, ensuring that the end result maintains a high level of clarity and intelligibility. The vocoder or alternative speech synthesis technologies may reconstruct the voice signal by generating the time-domain waveform based on the modified spectral and prosodic features.

Post-processing like equalization or dynamic range compression may be applied to enhance the naturalness and intelligibility of the synthesized voice.

These methods and procedures, as described, are representative of standard practices in the field of voice conversion technology, and are well within the grasp of one skilled in the art, as evidenced by their detailed descriptions in existing technical literature.

Details of these steps are known to the person of skill in the art from the technical literature, for example [Sisman, Berrak & Yamagishi, Junichi & King, Simon & Li, Haizhou. (2020). An Overview of Voice Conversion and Its Challenges: From Statistical Modeling to Deep Learning. IEEE/ACM Transactions on Audio, Speech, and Language Processing. 29. 10.1109/TASLP.2020.3038524.].

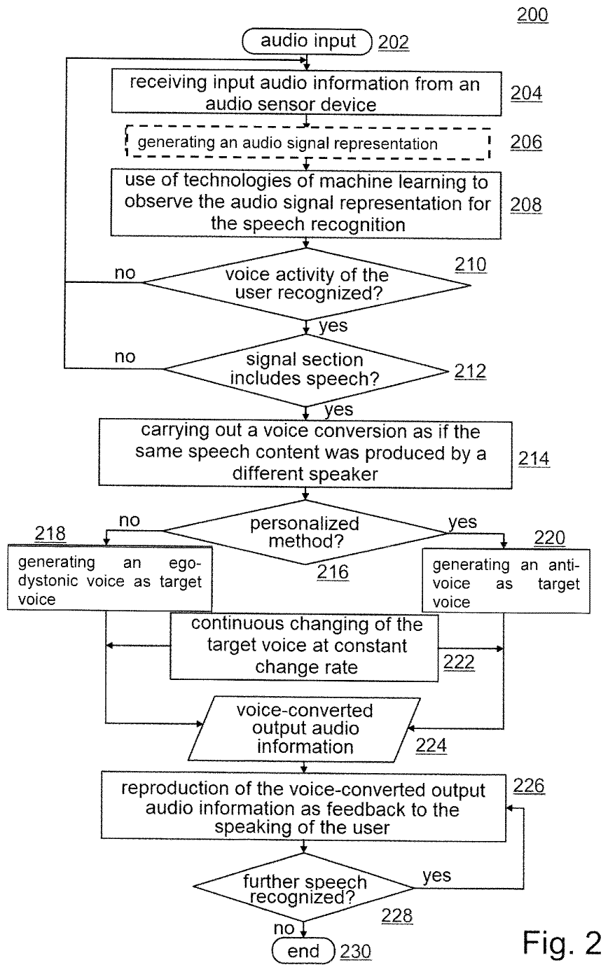

FIG. 2 shows a flow chart of a voice conversion method 200 according to a detailed exemplary embodiment, which is described below. The figure depicts an “end-to-end” process for converting the user's natural voice into a target voice in accordance with illustrative embodiments of the invention. It should be noted that this process is significantly simplified compared to a longer process that would be used in preferred embodiments to convert a voice. Consequently, the process includes many steps, that would likely be employed by persons of skill in the art. Additionally, some of the steps can be executed in a different order than shown, or can be performed simultaneously. Therefore, the person of skill in the art may modify the method as needed.

The method 200 starts with an audio input 202. In step 204, input audio information is received by an audio sensor device. In step 206, an audio signal representation is created. In step 208, machine learning technologies are applied to observe the audio signal representation for speech recognition. In step 210, it is determined whether a vocal activity of the user is detected. If not, the method reverts to step 204. If yes, it is determined in step 212 whether the current speech section contains speech. If not, the method reverts to step 204. If yes, voice conversion is performed in step 214, as if the same speech content was produced by a different speaker. It is determined in step 216 whether a personalized method is to be carried out. If not, an ego-dystonic voice is generated as target voice in step 218. If yes, an ego-dystonic anti-voice is generated as target voice in step 220. In both scenarios, a continuous change of the target voice at a constant change rate can optionally be carried out subsequently in step 222. The outcome of these steps is the voice-converted output audio information 224. In step 226, the voice-converted output audio information is played back as speech feedback to the user. In step 228, it is verified whether further speech is recognized. If yes, the method returns to step 226. If not, the method ends in step 230.

Certain operations may not be carried out in the exact order shown and described. Certain operations may not be carried out in a continuous series of operations, and various specific operations may be executed differently in different aspects.

In certain embodiments, the voice converter 118 is configured to create an anti-voice, which maximizes the perceptual deviations from the natural voice of the user. Contrary to the prior art, where a static distortion of speech is applied, this personalized approach is much more effective because it is specifically geared towards the individual's neural auditory processing mechanism (the neural recognition of one's own voice). This is described in one embodiment by means of a user-related personalized application of methods and technologies of voice conversion, as described below.

The goal of generating a personalized anti-voice is to improve the effectiveness in reducing stuttering compared to a non-personalized method. This can be expected for the following reasons:
study results show that a complexly combined AAF with strong distortion of the user's voice has a higher efficiency in reducing stuttering than a simple AAF with mild distortion [Hudock, Daniel & Kalinowski, Joseph. (2014). Stuttering inhibition via altered auditory feedback during scripted telephone conversations. International journal of language & communication disorders/Royal College of Speech & Language Therapists. 49. 139-47. 10.1111/1460-6984.12053.]. More specifically, their findings reveal that multiple combinations of delayed auditory feedback (DAF) and frequency-altered feedback (FAF) reduce stuttering more effectively than single combinations of these techniques. This suggests that the effectiveness of an AAF-based voice modification in reducing stuttering depends on the degree of the perceptual deviation from the natural voice of the user. Therefore, a target voice, that maximizes this deviation, can thus expectably increase the effectiveness compared to a target voice, which is randomly assigned to the user, the degree of self-dissimilarity of which is arbitrary.
The deception of the sensory recognition of one's own voice, as described above, necessitates that the perceptual deviation of a converted voice from the user's natural voice is sufficiently strong. Being sufficiently strong is understood here such that the deviation should exceed the perceptual tolerance for natural fluctuations in one's own voice, because otherwise, the converted voice may (erroneously) be identified as the user's own voice. Whether the deviation is sufficiently strong requires individual determination, which is why a personalized voice conversion method is methodologically superior to a non-personalized method for stuttering reduction.

To maximize the perceptual deviation between the target voices and the natural voice of the user (hereinafter referred to as self-dissimilarity), suitable methods for quantifying self-dissimilarity are used in certain embodiments. Consequently, the voice converter 118 is adjusted to generate only target voices with a maximally high degree of determined self-dissimilarity. In some embodiments “maximally high degree of determined self-dissimilarity” concerns at least one acoustic characteristic relevant for perceptual recognition of a voice identity. Both aspects are described in more detail below.

It may be preferred that the self-dissimilarity of the target voice compared to the user's voice is at least 10%, preferably at least 20%, more preferably at least 30%. Such a percentage rate can be determined based on one or several weighted quantifiable factors or parameters.

In the following, different methods and processes for quantifying the degree of self-dissimilarity will be described:
The self-dissimilarity can be determined using computer-based machine learning methods, which calculate a “speaker voice similarity metric”, by means of which a quantitative evaluation of the degree of dissimilarity between human voices can be made. Such a computer-based method for evaluating the voice similarity of speakers is described in [Hu, Chenghung & Peng, Yu-Huai & Yamagishi, Junichi & Tsao, Yu & Wang, Hsin-min. (2022). SVSNet: An End-to-end Speaker Voice Similarity Assessment Model. IEEE Signal Processing Letters. 29. 1-1. 10.1109/LSP.2022.3152672.]. The audio processing device can be configured to execute this computer-assisted method.

Alternatively, the self-dissimilarity can be determined using automatic speaker recognition systems (abbreviation: ASR), which are suitable for speaker identification or speaker verification. Such ASR systems based on deep learning methods are also described in the technical literature [Bai, Zx & Zhang, Xiao-Lei. (2021). Speaker recognition based on deep learning: An overview. Neural Networks. 140. 65-99. 10.1016/j.neunet.2021.03.004.]. The audio processing device can likewise or alternatively be configured for carrying out such a speech recognition.

Such ASR systems can be used to determine the degree of match between two speech samples, by computing an assessment that reflects the probability of the samples originating from the same or different speakers. For instance, a similarity value can be calculated between the voices registered in the system and a test voice, and this value can be compared with a predetermined threshold value. This threshold value serves to differentiate between the hypothesis that the samples originate from the same speaker, and the contrary hypothesis. For details, see, for example, a typical ASR-based speaker identification system, as in [Bai, Z., & Zhang, X. L. (2021). Speaker recognition based on deep learning: An overview. Neural Networks, 140, 65-99.]

As a second alternative for determining self-dissimilarity, one or several fundamental audio features, known for recognizing similarities between two speech signals, can be compared. The audio processing device is preferably configured for the comparison of one or several of these basic audio features. For example, parametric distances can be determined, which are geared towards measuring the difference between pairwise comparisons of voices, such as the “speech distortion index (SDI)”, the “mel cepstral distance (MCD)”, the “cepstrum distance (Cep)”, the “segmental signal-to-noise ratio (SSNR) improvement” and the “scaleinvariant source-to-noise ratio (SI-SNR)”. A detailed description of these metrics and their application in speech recognition using deep learning methods can be found in [Bai, Z., & Zhang, X. L. (2021). Speaker recognition based on deep learning: An overview. Neural Networks, 140, 65-99.]

As a third alternative for determining self-dissimilarity, data protection metrics, utilized in the field of speaker anonymization, can be calculated. These metrics quantify the degree of anonymization of a certain speech transformation method, i.e., the degree to which a speaker's identity is obscured. An example of this is the “de-identification” metric (abbreviation: DelD) described by Noé et al. (2022) [Noé, P. G., Nautsch, A., Evans, N., Patino, J., Bonastre, J. F., Tomashenko, N., & Matrouf, D. (2022). Towards a unified assessment framework of speech pseudonymization. Computer Speech & Language, 72, 101299.] The audio processing device is preferably configured for calculating such a data protection metric.

Study results show that such data protection metrics correlate with the subjective human perception of similarity when hearing a modified voice [Das, R. K., Kinnunen, T., Huang, W. C., Ling, Z., Yamagishi, J., Zhao, Y., . . . & Toda, T. (2020). Predictions of subjective ratings and spoofing assessments of voice conversion challenge 2020 submissions. arXiv preprint arXiv:2009.03554.]. In this regard, they are suitable for determining self-dissimilarity in the method described here.

Subjective hearing tests represent another method that can be employed in the described method for determining self-dissimilarity. In this method, users can provide their impression of similarity using metric scales. For instance, users are asked, to rate individually played back speech samples (audio recordings) along a Likert scale ranging from 1 (“completely similar to one's own voice”) to 9 (“completely dissimilar from one's own voice”). As alternative to the Likert scale, a visual analogue scale can be used, where responses are represented along a continuum using visual elements, such as “smileys”.

Alternatively to individual rating, the impression of similarity can also be assessed through pairwise comparisons. In this method, pairs of speech samples, representing either the user's natural voice or the target voices, are played back to the user, wherein it is the task of the user to evaluate the similarity between the pair on a scale of 1 (“both are very dissimilar”) to 9 (“both are very similar”). In this method, each comparison can either be carried out between voices of the same speaker or of different speakers.

Details relating to these hearing test methods can be found in the technical literature [Gerlach et al. (2020) Exploring the relationship between voice similarity estimates by listeners and by an automatic speaker recognition system incorporating phonetic features” in Speech Communication, 124, 85-95.] and are known to the person of skill in the art. The results can be evaluated by means of known statistical methods, such as mean value calculations, standard deviations and correlation coefficients.

Referring once again to the basic concept of the anti-voice, the creation of an anti-voice is typically based on a conversion of the voice of the user into a (maximally different) target voice, which represents the voice of a certain speaker (A, B, C, [ . . . ]). In some embodiments of the invention, the creation of an anti-voice is based on a conversion of individual features of the voice identity, which are relevant for the acoustic identification of a person. This comprises, but is not limited to gender, age and dialect-related way of speaking.

For the creation of the anti-voice, different variations are provided, which are described below:

Variation 1 for generating the anti-voice:
Step 1: Recording of speech samples of the user. In one embodiment, these samples consist of continuous audio signal waveforms with a duration of at least 2 to maximally 60 seconds. The samples can be created by repeating lines of text or by the user speaking freely, wherein the user is supported by corresponding instructions, preferably on the user surface.
Step 2: Generating speech samples of the target voices. These samples likewise consist of continuous audio signal waveforms with a duration of at least 2 to maximally 60 seconds. The speech samples of the user serve as input for the voice conversion used by the method described here. The selection of the target voices depends on the used voice conversion method and can either consist of available profile voices or of a representative selection of generatable target voices. The result of this step are speech samples, which, with regard to speech, content and duration, are identical to those of the user, but differ with regard to the voice of the speaker.
Step 3: Calculating a quantifiable self-dissimilarity value for each speech sample of the target voices. This can be carried out by means of objective methods, including those of machine learning, as well as by means of subjective hearing test methods, both as described above. Self-dissimilarity can be expressed by a value in the interval [0, 1], wherein 1 stands for “very similar to one's own voice” and 0 for “very dissimilar from one's own voice”.
Step 4: Identification of suitable target voices based on two alternative methods:
   identification using statistical interference methods: the calculated self-similarity values are compared with predefined threshold values. For instance, a certain threshold value may represent the hypothesis (H1) that the speech samples of the target voices are maximally self-dissimilar, while another threshold value represents the opposite hypothesis (H0). Only target voices for which the hypothesis (H1) holds true are classified as suitable for the voice conversion (H1).
   Identification by means of algorithm-based methods: the determined self-similarity values are used to create a similarity matrix. In such a matrix, voices are represented in a way that similar voices are closer each other, and dissimilar voices are farther apart from one another. This matrix can be utilized to identify target voices that have the greatest distance from the user's voice. This identification can be achieved using well-known statistical methods for measuring similarity or distance, such as the Euclidian distance. Such statistical methods are well-known to the person of skill in the art.

For example, a dissimilarity score may be calculated using the Euclidean distance method, where the anti-voice and the user's natural voice are each represented as points in a multidimensional acoustic feature space. The Euclidean distance (D) may be computed as D=√[(x2−x1)²+(y2−y1)²+(z2−z1)²], where x, y, and z represent specific acoustic parameters. If this calculated distance surpasses a pre-determined threshold, indicative of substantial dissimilarity, the anti-voice is considered sufficiently distinct from the user's natural voice. For instance, a threshold set at a value such as 5.0, and an actual dissimilarity score of approximately 6.4, would indicate that the anti-voice significantly diverges from the natural voice as per the algorithm's criteria.

In one embodiment, the voice converter executes the described conversion steps exclusively using the determined (maximally self-dissimilar) target voices. Steps 1-3 are preferably performed during a setup phase, i.e. prior to applying the method described here.

The term “maximal” dissimilarity (and likewise expressions) for the purpose of identifying or generating target voices, is defined herein as the following quantifiable criteria:
1. Threshold Value: “Maximal” dissimilarity is defined as a dissimilarity score exceeding a pre-established threshold value in the Euclidean distance metric.
2. Percentile Ranking: A voice is considered to have “maximal” dissimilarity if it falls within the top 30% of voices, preferably top 20%, even more preferred top 10% in terms of distance from the user's voice on the similarity matrix.
3. Standard Deviation: “Maximal” is defined as a dissimilarity value that lies a specific number of standard deviations (e.g., two) above the mean value within the dataset.
4. Comparative Measure: “Maximal” dissimilarity is characterized as the distances falling into the highest 30% or the farthest 30% voices from the user's voice within the matrix.

Absolute Cut-off: An absolute cut-off point is established, beyond which any voice's dissimilarity score is deemed “maximal”, based on empirical evidence or expert consensus on perceptual thresholds of human sensory based voice recognition. Variation 2 for generating the anti-voice:
Steps 1 to 3 are performed in the same manner as in variation 1.
Step 4: adaptation of the voice conversion processes by using a generative method. The voice converter uses a method of machine learning suitable for the continuous control and individual adaptation during the generation of target voices. The determined self-dissimilarity values are considered in such a way that only target voices with maximal dissimilarity from the user's voice are generated. This is achieved by using a corresponding conditional statement (for example a selection operator) for controlling the generative method, which is known for a person of skill in the art in the field of computer technology.
Step 5: carrying out the conversion with the adapted model. The voice converter performs the described steps with the adapted generative method.

Variation 3 for generating the anti-voice:
Step 1: determining certain features of the user, which are relevant for the acoustic identification of a person. Features of the audio signal representation of the speech of the user, which are important for the acoustic identification of a person, are extracted and analysed in a setup phase. Machine learning methods, as utilized in contemporary automatic speech recognition systems, are applied for this purpose. This analysis may involve the determination of the gender or age of the user, as described in [Tursunov A, Mustaqeem, Choeh J Y, Kwon S. Age and Gender Recognition Using a Convolutional Neural Network with a Specially Designed Multi-Attention Module through Speech Spectrograms. Sensors (Basel). 2021 Sep. 1; 21(17):5892. doi: 10.3390/s21175892. PMID: 34502785; PMCID: PMC8434188.]. Additionally, the presence of a linguistic dialect of the user can be determined, as described in: [Mikhailava, V.; Lesnichaia, M.; Bogach, N.; Lezhenin, I.; Blake, J.; Pyshkin, E. Language Accent Detection with CNN Using Sparse Data from a Crowd-Sourced Speech Archive. Mathematics 2022, 10, 2913. https://doi.org/10.3390/math10162913].

Moreover, the determination and extraction of any acoustic parameter outlined in Step 2 of the voice conversion method, as previously described, is encompassed within this scope. This includes, but is not limited to, analyses of formants, fundamental frequency (F0), intonation, intensity, and duration of the speech signal. The analysis may employ spectral features, notably Mel cepstral coefficients (MCEP), linear predictive cepstral coefficients (LPCC), and line spectral frequencies (LSF). Furthermore, this step extends to a thorough assessment of voice quality using a range of metrics, which encompass, but are not restricted to, jitter (indicating frequency variation), shimmer (reflecting amplitude variation), and the Harmonics-to-Noise Ratio (HNR). Such comprehensive analysis ensures a detailed evaluation of voice quality. Additionally, the process includes extracting a broad spectrum of acoustic features from the source voice. These features, critical in defining the distinctive characteristics of the user's voice to be converted into an anti-voice, include pitch, timbre, duration, and formant frequencies, but are not confined to these alone. Step 2: conversion of the determined features. The voice converter performs the conversion of the identified features by using suitable methods of machine learning, including, but not limited to

| | |
|---|---|
| - | inverted gender-specific conversion (male to female voice and vice versa), as |
| | described in [https://speechify.com/blog/female-voice- |
| | changer/?landing_url=https%3A%2F%2Fspeechify.com%2Fblog%2Ffemale-voice- |
| | changer%2F] |

inverted age-specific conversion (old to young voice and vice versa), wherein an old voice preferably comprises one or several average features of a voice of a person over 50 years of age, and a young voice preferably comprises one or several average features of a voice of up to 25 years of age;
adding a linguistic dialect, which is not used by the user, as described here: [Nguyen, T. N., Pham, N.-Q., Waibel, A. (2022) Accent Conversion using Pre-trained Model and Synthesized Data from Voice Conversion. Proc. Interspeech 2022, 2583-2587, doi: 10.21437/Interspeech.2022-10729]

Moreover, the conversion step may be configured to maximize dissimilarity between the user's voice and the target voice in respect to at least one characteristic acoustic parameter determined in step 1.

In the context of generating an anti-voice, “maximal” dissimilarity in specific voice parameters is quantitatively defined by the following measures, each assessing the extent of variance in individual aspects of the voice, rather than the voice as a whole:
1. Threshold Value: A particular voice parameter is considered to exhibit “maximal” dissimilarity if its measurement exceeds a predefined threshold in the Euclidean distance metric, indicating a significant deviation in that parameter from the user's natural voice.
2. Percentile Ranking: A voice parameter achieves “maximal” dissimilarity if it ranks within the 30%, preferably top 20%, even more preferred top 10% in terms of its distance from the corresponding parameter of the user's voice, as depicted in a similarity matrix.
3. Standard Deviation: “Maximal” dissimilarity for a voice parameter is identified when its value is several standard deviations above the dataset's mean for that specific parameter, signifying a major divergence.
4. Comparative Measure: This criterion considers “maximal” dissimilarity in a voice parameter as being among the highest x % or the farthest y measurements from the user's voice parameter in the matrix, focusing on the most extreme differences.
5. Absolute Cut-off: An absolute cut-off point is set for each voice parameter, with values beyond this point classified as “maximal”. This cut-off is determined through empirical analysis or expert consensus, providing a clear, objective benchmark for perceptual thresholds for perceiving the respective acoustic parameter.

In some embodiments of the present disclosure, the voice converter can anonymize or pseudo-anonymize the voice of the user. The voice anonymization serves the purpose of suppressing personally identifiable information in the speech signal, while other attributes are maintained. The voice is changed, so that the identity of the speaker is obscured, if possible, but linguistic content, para-linguistic properties, comprehensibility and naturalness are maintained at the same time. Such a method is likewise suitable to create an anti-voice in the sense described here. Details relating to methods and technologies of the voice anonymisation can be found in the technical literature, for example:
F. Fang, X. Wang, J. Yamagishi, I. Echizen, M. Todisco, N. Evans, and J.-F. Bonastre, “Speaker anonymization using x-vector and neural waveform models,” in Speech Synthesis Workshop, 2019, pp. 155-160.
Tomashenko, N., Srivastava, B. M. L., Wang, X., Vincent, E., Nautsch, A., Yamagishi, J., Evans, N., Patino, J., Bonastre, J.-F., Noé, P.-G., Todisco, M., 2020a. Introducing the VoicePrivacy initiative. In: Proc. Interspeech 2020. pp. 1693-1697. http://dx.doi.org/10.21437/Interspeech.2020-1333.
Tomashenko, N., Wang, X., Miao, X., Nourtel, H., Champion, P., Todisco, M., . . . & Bonastre, J. F. (2022). The VoicePrivacy 2022 Challenge Evaluation Plan. arXiv preprint arXiv:2203.12468.
Paul-Gauthier Noé, Andreas Nautsch, Nicholas Evans, Jose Patino, Jean-François Bonastre, et al., Towards a unified assessment framework of speech pseudonymisation. Computer Speech and Language, 2022, 72, pp. 101299.

In certain embodiments, the voice converter can perform audio signal processing steps to modify the user's voice making it appear to emanate from an unnatural position in the simulated sound field. For this purpose, audio signals are generated that contain spatial audio cues giving the user the impression that their voice is coming from a certain position within a three-dimensional acoustic space, which does not correspond to the user's actual position (e.g., originating from behind, above or below the user). This shift in spatial positioning is significant for the auditory recognition of one's own voice because this recognition is influenced by the natural proximity to one's own voice (“proximity effect”) [Wen, W., Okon, Y., Yamashita, A. et al. The over-estimation of distance for self-voice versus other-voice. Sci Rep 12, 420 (2022). https://doi.org/10.1038/s41598-021-04437-8]. Therefore, such a manipulation is also suitable to create a personalized anti-voice in the sense used herein.

For this, known steps of user-based position detection and signal encoding are performed for this purpose known to the person of skill in the art of “spatial audio”, see [https://source.android.com/docs/core/audio/spatial].

To facilitate this, the voice converter may implement established procedures for user-based position detection and signal encoding, characteristic of ‘spatial audio’ technologies, as recognized by those skilled in the field [https://source.android.com/docs.core.audio/spatial]. Such steps include but are not limited to, the accurate tracking of the user's position and orientation in space, and the application of advanced signal processing algorithms to simulate a three-dimensional sound environment. These technologies enable the precise placement of audio cues in a virtual space, contributing significantly to the creation of a personalized anti-voice by altering the perceived location of the user's voice, thereby enhancing the dissociation of the user from their natural voice.

For this purpose, in certain embodiments aimed at generating a personalized anti-voice, the voice converter is configured to employ a range of spatial audio technologies. These technologies are designed to modify the perceived point of origin of the user's voice within a virtual three-dimensional auditory environment. The configuration encompasses various technologies, including, but not limited to:
1. Binaural Audio Processing: This process is essential for replicating a realistic spatial auditory experience via headphones. It involves manipulating the audio signal containing the user's speech to emulate natural hearing, including variations in timing, volume, and frequency response between the ears based on the sound source's location.
2. Integration of Head-Related Transfer Functions (HRTFs): The system may employ individualized HRTFs to tailor the spatial audio output. These functions, representing the unique auditory reception characteristics of an individual, enable the rendering of the anti-voice in a manner that accurately mimics natural sound perception from various unnatural spatial positions.
3. Dynamic Rendering Based on Head Orientation: Incorporating head tracking technology, such as gyroscopes integrated into the headphones or external sensors, the system dynamically modifies the sound field in response to the user's head movements. This feature maintains the spatial consistency of the anti-voice relative to the user's changing orientation.
4. Simulation of Virtual Acoustic Environments: The system may simulate various acoustic properties, including reverberation and echo, specifically adapted for headphone listening. These simulated properties are critical in augmenting the perception of the anti-voice as emanating from a distinct, unnatural location in the virtual environment.

The employment of these spatial audio technologies in certain embodiments enables the voice converter to deceive the perception of the user's voice originating from various unnatural locations within a virtual space when listened to through headphones. This spatial modification is effective in generating an anti-voice. It significantly aids in dissociating the user from their natural voice by altering its perceived location in space, an aspect crucial for deceiving auditory recognition of the user's own voice. This, in turn, contributes to increased speech fluency, as supported by the scientific rationale and surprising data mentioned herein.

In certain embodiments, the voice converter can use a method of digital speech synthesis, which is geared towards converting the user's voiced speech, i.e. speech produced with the involvement of a vocal tone, into unvoiced whispering speech, i.e. speech produced without the involvement of the vocal tone, as known from the technical literature [Cotescu, Marius & Drugman, Thomas & Huybrechts, Goeric & Lorenzo-Trueba, Jaime & Moinet, Alexis. (2019). Voice Conversion for Whispered Speech Synthesis. IEEE Signal Processing Letters.].

In certain embodiments of the present disclosure, a continuous change of the voice identity is provided, which will be described below. According to this aspect, a problem well-known in the scientific literature on AAF, namely that a constant feedback-based voice modulation can lead to user habituation and, consequently, a loss of its speech-enhancing effect. Such habituation effects are already known after 10 minutes of application, which is why the AAF method can quickly become ineffective for stuttering reduction. In other words, phenomena such as perceptual learning, adaptation, or familiarization (subsequently referred to as habituation) can plausibly account for why a static modulation of a user's own voice—as commonly employed in the prior art—may rapidly lose effectiveness in reducing stuttering. In contrast, a target voice identity that undergoes a continuous change remains ego-dystonic in perceptual voice recognition, thereby preventing these effects from undermining a fluency-enhancing impact.

To counteract this undesirable habituation, the voice converter is, in some embodiments, configured to induce a continuous change in voice identity. The user's natural voice is converted in such a way that the target voice undergoes a gradual and steady change over time. This method ensures that the target voice consistently presents novelty from a neural perspective, regardless of the duration of the feedback-based voice modulation. Therefore, such continuous change is suitable in sustaining the stuttering-reducing effect, even with the user's regular application.

The voice converter systematically alters the voice identity, ensuring the change is continuous and occurs at a constant rate over time. In certain embodiments, the rate of change is selected to be subtle enough to remain, if possible, below the threshold of conscious perception of acoustic changes. This approach leverages the phenomenon of “change deafness”, which suggests that changes in acoustic stimuli, including human voices, can remain undetected if they occur very slowly [Neuhoff J G, Wayand J, Ndiaye M C, Berkow A B, Bertacchi B R, Benton C A. Slow change deafness. Atten Percept Psychophys. 2015 May; 77(4):1189-99. doi: 10.3758/s13414-015-0871-z. PMID: 25788038]. This suggests that a user, at a very slow rate of change, might not actively perceive actual changes in the voice conversion or only do so with increased attention. The application of such a systematic method for continuous voice modification can lead to improved listening comfort, compared to methods based on randomness or quasi-randomness, as it avoids abrupt and therefore distracting changes in voice identity.

In some embodiments, change rate is understood to be the speed, at which a speaker identity 1 completely transitions into a perceptibly different speaker identity 2. The change rate can be expressed in percent per second. To attain a change deafness in the above-described sense and to simultaneously maintain the effect of the sensory or neural novelty, a change rate of at least 0.01% per second and maximally 1% per second can be useful.

Subsequently, various possibilities for the continuous change of voice identity according to embodiments of the methods disclosed here are described.

Changes by means of fading: in this embodiment, the voice converter utilizes a technique for the continuous change of the voice identity by cross-fading between target voices. For this purpose, digital audio signal processing techniques are used that enable a smooth, seamless transition between two audio signals. The ratio of the new voice is continuously increased in relation to the old voice, which leads to an even fading of different voices. For example, the fading can occur from “speaker identity 1” to “speaker identity 2” and then to “speaker identity 3”, as illustrated in the figures. During the fade between the discrete speaker identities, hybrid intermediate voices are created that combine features of the blended target voices.

A typical example of the progression of a continuous target speaker conversion, measured in degree of change per time unit, is as follows:

| Time | Input | Percentage | Input | Percentage |
|---|---|---|---|---|
| (t) | Signal 1 | (%) | Signal 2 | (%) |
| 1 | “target voice 1” | 100% | “target voice 2” | 0% |
| 2 | “target voice 1” | 90% | “target voice 2” | 10% |
| 3 | “target voice 1” | 80% | “target voice 2” | 20% |
| 4 | “target voice 1” | 70% | “target voice 2” | 30% |
| 5 | “target voice 1” | 60% | “target voice 2” | 40% |
| 6 | “target voice 1” | 50% | “target voice 2” | 50% |
| 7 | “target voice 1” | 40% | “target voice 2” | 60% |
| 8 | “target voice 1” | 30% | “target voice 2” | 70% |
| 9 | “target voice 1” | 20% | “target voice 2” | 80% |
| 10 | “target voice 1” | 10% | “target voice 2” | 90% |
| 11 | “target voice 1” | 0% | “target voice 2” | 100% |
| 12 | “target voice 3” | 10% | “target voice 2” | 90% |
| 13 | “target voice 3” | 20% | “target voice 2” | 80% |
| 14 | “target voice 3” | 30% | “target voice 2” | 70% |
| 15 | “target voice 3” | 40% | “target voice 2” | 60% |
| 16 | “target voice 3” | 50% | “target voice 2” | 50% |
| 17 | “target voice 3” | 60% | “target voice 2” | 40% |
| 18 | “target voice 3” | 70% | “target voice 2” | 30% |
| 19 | “target voice 3” | 80% | “target voice 2” | 20% |
| 20 | “target voice 3” | 90% | “target voice 2” | 10% |
| 21 | “target voice 3” | 100% | “target voice 2” | 0% |

To attain a particularly seamless blending of the target voices, the method of cross-fading, which is also used in sound engineering, can be used in some embodiments. This method is based on a step-by-step reduction of the volume of the current voice and a simultaneous step-by-step increase of the new voice. For example, the audio signal, which represents the first target voice, can be faded out gradually, while the audio signal, which represents the second target voice, is faded in to the same extent at the same time.
As an alternative, any digital sound synthesis technology known to the person of skill in the art can be used that is capable to create a seamless transition between two audio signals. This computer-based technology is similar to the morphing technologies known from the image and video processing for visual material, as it combines two source sounds in such a way that a new hybrid intermediate sound is created, containing characteristic properties of both. One such technology can be cross-synthesis. In this process, the spectral properties of two audio signals are combined, wherein the first signal can be referred to as “modulating signal” and the second as “carrier signal”. In the method presented here, the modulating signal represents a certain target voice, while the carrier signal represents a second, perceptually distinguishable target voice. The result of this combination is an audio signal representation of a new target voice that exhibits features of both. Additional options for generating a seamless transition include the application of other technologies of digital sound synthesis, including, but not limited to: the spectral modelling synthesis, in the case of which the frequency spectrum of a sound is manipulated.
the additive synthesis, also referred to as additive re-synthesis, in the case of which simple waveforms are combined to create more complex sounds.
the granular synthesis, in the case of which a sound is broken down into small segments (“grains”) and these grains are manipulated with a duration of 1-5 milliseconds to generate new sounds.
the format synthesis, in the case of which the acoustic resonances of the human vocal tract are simulated to generate synthetic speech sounds.
as well as any combination of the mentioned synthesis methods.

The mentioned technologies are known from respective technical publications, for example [Roads, Curtis (2023). The Computer Music Tutorial, second edition, MIT Press Ltd (ISBN 0262044919); Smith J. O. & Stanford University. (2011). Spectral audio signal processing. W3K.)], and therefore, a detailed description is omitted here.

Furthermore, those digital sound synthesis technologies can be applied, which are based on machine learning principles and enable a smooth and seamless blending of two target voices. A known example of this is the software application “Vocaloid” by YAMAHA Corporation, Hamamatsu, Shizuoka, Japan [https://www.vocaloid.com/en/]. It is known to the person of skill in the art, how such a software application can be utilized for effecting gradual transition between two target voices. The audio processing device 104 preferably comprises such a software.

Subsequently described is a method for generating a continuous voice change through fading according to an embodiment:
Step 1 (speech input): the sensor unit generates an audio signal representation of the user's speech, which is used as input for the voice converter.
Step 2 (voice conversion): conversion of the user's natural voice into two distinguishable target voices, each represented by means of a continuous audio signal waveform. For example, a first waveform, which represents target voice 1, and a second distinguishable waveform, which represents target voice 2.
Step 3 (fading): creation of a seamless transition between the two waveforms using technologies such as crossfade or cross-synthesis. Individual steps for performing the crossfade are described in [Langford (2017). Digital audio editing: correcting and enhancing audio in pro tools logic pro cubase and studio one. Focal Press.]. The individual steps for performing a cross-synthesis are described in [Smith (2011). Spectral audio signal processing. W3K]. The selected fading technology is preferably controlled in such a way that the audio signal representing the target voice 1, is faded out gradually, while the audio signal representing the target voice 2, is simultaneously faded in proportionately to the same extent. The speed of fading is determined by a constant change rate (G). This change rate corresponds to the speed at which a target voice 1 completely transitions into a perceivably different target voice 2 and can be expressed in percent per second.

Over time, the target voices are successively replaced, with the sequence being permuted in such a way that repetitions are minimized.

The result of this fading step is a continuous audio signal waveform that represents the user's natural voice in predetermined sequence of target voices and with a specified fading speed.

Step 3 (output): transfer of the audio signal waveform to the mobile hearing system of the user.

The described steps are performed in real time or approximately in real time, until the speaking episode has ended or until the speech recognizer classifies a segment of the signal as “non-speech”. The speech recognizer is preferably a computer program or a section of a computer program on the audio processing device.

Subsequently, a method for changing the voice identity by controlling an customizable model of the voice conversion according to one embodiment is described: In this embodiment, the continuous change of the voice identity is carried out during the step of the voice conversion. For this purpose, a generative method of voice conversion is used and accordingly adapted. Such a method can generate fictitious (proportionally composed) speaker voices whose vocal properties can be gradually adjusted. One such method, based on principles of machine learning, is described, in [Ho, T. V. & Akagi, M. (2021). Cross-Lingual Voice Conversion With Controllable Speaker Individuality Using Variational Autoencoder and Star Generative Adversarial Network. IEEE Access, 9, 47503-47515.]. With such a model, a linear interpolation between different speaker profiles is possible, which can be controlled in such a way that the generated target voice changes continuously over time.

Subsequently, a method for generating a continuous voice change by adjusting a generative model according to one embodiment is described: Step 1 (speech input): the sensor unit generates an audio signal representation of the user's speech, which is used as input for the voice conversion.

Step 2 (voice conversion): the voice converter uses a generative (customizable method of the voice conversion, which is geared towards the linear interpolation between two speaker profiles 122 stored in a system database, in order to produce a continuous seamless change between target voices. Over the course of the interpolation, hybrid voices are created that combine features of the two speaker profiles. The adjustment of the method is achieved by using a conditional statement, which is suitable to carry out the linear interpolation at a certain speed and in a certain sequence of target voices. The speed is determined by a certain constant change rate (G). This rate of change corresponds to the speed at which one target voice 1 completely transitions into a perceptibly different target voice 2 and can be expressed in percentage per second. The result of this step is the creation of a continuous audio signal waveform, which represents user's natural voice in a predetermined sequence of target voices and with a defined transition speed. Step 3 (output): transfer of the audio signal waveform to the mobile hearing system of the user.

The described steps are performed in real time or approximately in real time and continue until the speaking episode has ended or until the speech recognizer classifies a segment of the signal section as “non-speech”. According to one embodiment, the voice converter comprises a memory function, which continuously stores the current state of the voice conversion using suitable parameter values in a database 124 (see FIG. 1) and makes it available for constant control. When the speaking episode ends or the method is stopped, the current settings are preferably stored. In the case of a new speaking episode or when continuing the method, the stored settings are preferably retrieved, and the voice conversion is continued in the same state. This avoids abrupt and distracting changes in the target voice, thereby improving the listening comfort of the method.

In some embodiments, the modification of the target voice is carried out “silently” during a speaking episode and is reproduced only at the beginning of the next speaking episode. Thus, the target voice remains constant during a speaking episode, and the modification occurs only between two consecutive speaking episodes. The degree of the modification depends on the duration of the user's previous speaking time and is determined by the described change rate (G). These embodiments can be geared towards detecting speaking pauses and providing this information to the voice converter. In some embodiments, the voice converter can use methods of digital audio signal processing, which are capable to acoustically simulate changes to the human vocal apparatus (vocal tract), such as stretching, shortening, widening or constriction. Such methods are known, for example, through the computer program “Throat” by the Antares Audio Technologies [Source: https://www.antarestech.com/products/vocal-effects/throat]. The voice converter can be geared towards using voice profiles of target speakers, which are not stored on the system described here, but are instead stored, for example, in a cloud-based manner or in a wireless computer network. In some embodiments, the voice converter can maintain the user's natural pitch when generating the target voice. For this purpose, a voice conversion model based on machine learning is used, in the case of which the feature “F0” is decoupled from the process of the voice conversion. Such a model is known from the following publication [Watanabe, C., & Kameoka, H. (2022). DisC-VC: Disentangled and F0-Controllable Neural Voice Conversion. arXiv preprint arXiv:2210.11059.]. In some embodiments, the audio signal representation, produced by the sensor unit 106, is monitored for user speech activity. For this purpose, a current method of machine learning is used, which is capable to divide the audio signal representation into time segments with and without speech of the user. This process is referred to as “speech recognizer” or “voice recognizer” 120, respectively (see FIG. 1) and serves as a pre-processor by transmitting the audio signal representation in discontinuous segments to the voice converter 118. It is ensured thereby that the voice conversion is triggered only in response to recognized speaking activities of the user, thus avoiding unnecessary distortions caused by non-speech signals, such as ambient noises or movement noises of the user. Particularly, when using an anti-stuttering method in verbal dialogue, which involves phases of listening, reliable differentiation between the speech produced by the user and third-party speech is of essential importance. The speech recognizer is thus preferably configured specifically for self-voice recognition. The discontinuous transmission also reduces the average memory, CPU and power consumption of the audio processing system used. Resource-intensive computer processes of the voice conversion are preferably only activated during the user's speaking phases. The speech recognizer 120 can use any machine learning method known in the context of speech activity detection or voice activity detection, such as, those used in applications in the fields of telephony, audio conferences, keyword recognition, automatic speech recognition, echo suppression, sound source localization and tracking and speech enhancement. The speech recognizer can be understood as a type of state machine (finite automation), which differentiates between two discrete states: “speech” and “no speech”. “Speech” refers here to sections of the audio signal where the user actively speaks words, while “no speech” refers to sections of the audio signal where no “speech” of the user is present. The speech recognizer identifies the state for a certain time segment of the audio signal representation and continuously updates this state. The start and end times of a speaking episode can be determined. When the speech recognizer identifies the current segment of the audio signal as “speech”, the transmission of the concurrently captured audio signal representation from the audio sensors to the voice converter is triggered. However, if no speech is detected, preferably no specific action is taken and the captured audio signal is not further transmitted.

In one embodiment, the speech recognizer performs the steps described below for the speech recognition:
Step 1 (extraction of acoustic features from the audio signal representation): performing an algorithm-based extraction from the observed audio signal representation, including zero-crossing rate, pitch, signal energy, Mel-frequency cepstral coefficients (MFCCs) or pitch periods.

An overview of suitable acoustic features and methods for their extraction for computer-assisted voice recognition is available in [Graf, Simon & Herbig, Tobias & Buck, Markus & Schmidt, Gerhard. (2015). Features for voice activity detection: a comparative analysis. EURASIP Journal on Advances in Signal Processing. 2015. 91. 10.1186/s13634-015-0277-z./paragraph 411]. Step 2 (analysing the extracted features using a machine learning model): utilizing a trained model such as deep neural network (DNN), recurrent neural network (RNNs) and convolutional neural networks (CNNs) to analyse the acoustic features extracted in step 1.
Information on the computer-based steps involved in the application currently successful models for speech recognition are described in the literature, for example, in: Mihalache, S., & Burileanu, D. (2022). Using Voice Activity Detection and Deep Neural Networks with Hybrid Speech Feature Extraction for Deceptive Speech Detection. Sensors, 22(3), 1228. MDPI AG. Retrieved from http://dx.doi.org/10.3390/s22031228
N. Ryant, M. Liberman, J. Yuan, Speech activity detection on YouTube using deep neural networks., in: Proceedings of the Annual Conference of the International Speech Communication Association, 2013, pp. 728-731.
G. Gelly, J.-L. Gauvain, Optimization of rnn-based speech activity detection, IEEE/ACM Transactions on Audio, Speech, and Language Processing 26 (2017) 646-656.
S. Thomas, S. Ganapathy, G. Saon, H. Soltau, Analyzing convolutional neural networks for speech activity detection in mismatched acoustic conditions, in: Proceedings of IEEE International Conference on Acoustics, Speech and Signal Processing, 2014, pp. 2519-2523.
R. Yang, J. Liu, X. Deng, and Z. Zheng, “A low complexity long short-term memory based voice activity detection,” in Proc. IEEE 22nd Int. Workshop Multimedia Signal Process. (MMSP), September 2020, pp. 1-6.

The used model makes a decision regarding the presence of “speech” or “non-speech” in the observed signal segment, which can also be a probability value. Step 3: (triggering the voice conversion):
if the state is classified as “speech” or with high probability as “speech”, the observed signal section is transferred to the voice converter, and the voice conversion method is initiated. If the state is classified as “non-speech”, no specific action is triggered, and the currently observed signal section is not further processed.
   The mentioned steps are performed with the lowest possible latency, i.e., in real time or almost in real time. According to one embodiment, the speech recognizer, for the purpose of optimizing self-voice recognition, can use a method of “own-voice detection”, which is specifically designed for detecting the presence of the user's speech within the audio signal representation, while ignoring speech from other speakers. This is intended to reduce false triggers caused by speech activity of others. This can be achieved in two alternative ways: The speech recognizer monitors the signal from the structure-borne sound sensor of the audio sensor system, which represents the bone vibrations during the user's speech in order to make a decision about the presence of speech. This method, using structure-borne sound signals are for own-voice recognition, is described in [Burns & Jensen, Method and apparatus for own-voice sensing in a hearing assistance device, US patent 20210120347A1]. The speech recognizer can employ this method to detect speech by means of multi-sensory monitoring and evaluation of both structure-borne sound and airborne sound signals. A similar method, using structure-borne sound as well as airborne sound-based signals are used for own-voice recognition, is described in [Pertilä, P., Fagerlund, E., Huttunen, A., & Myllylä, V. (2021). Online Own Voice Detection for a Multi-Channel Multi-Sensor In-Ear Device. IEEE Sensors Journal, 21, 27686-27697.]. The speech recognizer can apply the machine learning operations described therein in the same or similar manner to evaluate speech-related signals within the here presented method.

The second method for self-voice recognition involves personalizing a system for determining the speaker identity (“speaker verification”) or of a system for speech activity detection or voice activity detection. This technology, which is known from voice assistance systems like Apple's “Siri” allows a computer to automatically identify a certain person by their voice. This is possible because a person's voice has unique characteristics that are due to the physiological vocal tract and manner of speaking. In speaker identification, features of the currently observed audio signal representation are compared with features of speech samples stored in a database. The database can be present on a memory in the wearable hearing device. Preferably, however, it is stored externally. With sufficient matching, the audio signal representation is evaluated as “user voice”, otherwise as “non-user voice”. There are already known methods of speaker identification, which are based on models of machine learning, which are described in different sources, for example [Bai, Z., & Zhang, X. L. (2021). Speaker recognition based on deep learning: An overview. Neural Networks, 140, 65-99; Ding, S., Wang, Q., Chang, S. Y., Wan, L., & Moreno, I. L. (2019). Personal VAD: Speaker-conditioned voice activity detection. arXiv preprint arXiv:1908.04284.]. The speech recognizer can perform the computer-based operations mentioned in the sources in the same or in a similar way for text-independent speaking situations. In some embodiments, the speech recognizer can recognize speech impacted by stuttering by using methods of machine learning. This is achieved by training and recognizing non-verbal, vocally produced events that are known to be typical for stuttering or typical for stuttering-related speech behaviour of the specific user. Such events are known to the person of skill in the art. A detailed description of such a method can be found in the literature: [Lea, Colin & Huang, Zifang & Jain, Dhruv & Tooley, Lauren & Liaghat, Zeinab & Thelapurath, Shrinath & Findlater, Leah & Bigham, Jeffrey. (2022). Nonverbal Sound Detection for Disordered Speech].

The speech recognizer can use any combination of the mentioned methods to recognize the user's speech in the audio data. The detection of a speaking episode can be associated with uncertainties and cannot always ensure a precise capture of the user's speech.

Some embodiments of the invention comprise an optimization function for adapting and for improving the voice conversion for the stuttering reduction of a certain user based on success. In particular, machine learning methods can be used for this purpose. For example, these methods can learn an input-output function, wherein various target voices or features of target voices serve as input, and the reduction of stuttering episodes is measured as output. Features of stuttering episodes can be determined from the literature [Bloodstein O. Ratner N. B. & Brundage S. B. (2021). A handbook on stuttering (Seventh). Plural Publishing]. Therefore, the method described here can be optimized in a self-adapting manner with increasing use by the user.

In more detail, the proposed invention integrates a self-adapting algorithm within a machine learning framework, aimed at reducing stuttering in speech. This algorithm operates on the principles of supervised machine learning, utilizing techniques such as reinforcement learning or adaptive neural networks. It is specifically programmed to recognize and analyze speech patterns, focusing on identifying characteristics of stuttering, including variations in speech flow, frequency of stuttering episodes, and types of disfluencies.

As the user interacts with the system, their speech data serves as the primary input. This data is continuously processed to evaluate the effectiveness of the system's stuttering intervention (as measured, e.g., be the reduction of the frequency of stuttering-events). Based on this analysis, the algorithm dynamically adjusts its parameters, allowing for a tailored and personalized approach to speech modification. The system thus evolves through an iterative learning process, ensuring that it becomes more attuned to the specific speech patterns and needs of each user over time.

This iterative learning process involves analyzing the speech data to identify stuttering episodes, applying voice conversion techniques to modify the speech output (e.g., output another ego-dystonic or anti-voice to the user or modify one or several acoustic properties thereof as mentioned herein) in real-time to reduce stuttering, gathering feedback on the effectiveness of these modifications, and updating the learning model based on this feedback. This process enhances the future performance of the system.

To optimize the algorithm, advanced techniques like gradient descent and backpropagation may be employed. This continuous optimization ensures that the model adjusts its parameters in response to new data and feedback, improving the effectiveness and specificity of the system's interventions.

The result is a dynamic voice-conversion system that offers personalized stuttering reduction interventions, improving its predictive and mitigative capabilities regarding stuttering episodes as the user continues to interact with it. The self-adapting algorithm, therefore, represents a novel approach to stuttering therapy that adapts to the unique speech patterns and therapeutic/training progression of each individual user. The voice conversion system used for the method can be operated in one mode or several modes. The first mode can be characterized in that an ego-dystonic target voice is created. The second mode can be a “default mode” in the case of which the used hearing system carries out a different function, for example the function of music playback with the help of or without connection to a “client” computer device. The user can thus use the same device for improving his speech performance as well as for entertainment purposes.

In other words, the present invention relates to a voice conversion system characterized by its capability to operate in a plurality of modes to cater to various functionalities. The system is designed to be compatible with standard operating systems, such as iOS and Android, thereby enhancing its utility and ease of use.

The system is configurable to alternate between multiple distinct operational modes, each tailored to fulfill specific user requirements, providing versatility within a unified framework.

In a first operational mode, the system is dedicated to voice conversion, specifically generating an ego-dystonic target voice. This mode is advantageous for therapeutic or training applications, where modifying voice characteristics can significantly aid in areas such as speech therapy or other specialized vocal uses.

A second operational mode, herein referred to as the “default mode,” enables the system to function compatibly with standard operating systems like iOS or Android. In this mode, the system can perform various typical functions associated with these platforms, for instance, music playback. This integration facilitates user access to a wide range of standard features and applications available on these platforms, negating the need for additional devices or interfaces.

This dual-functional design of the system serves both therapeutic and entertainment purposes, leveraging voice conversion capabilities alongside standard operating system functionalities. Such a design offers users the convenience of a single device that addresses both specific voice conversion requirements and general entertainment or communication needs.

The system's alignment with universally recognized operating systems such as iOS or Android ensures a user-friendly interface, capitalizing on the users' existing familiarity with these systems. This invention provides a comprehensive solution for users with diverse needs, embodying the fusion of advanced voice conversion technology with everyday personal device use.

Although some aspects have been described as part of a device, it is clear that these aspects also represent a description of the corresponding method, wherein a block or a device corresponds to a method step or a function of a method step. Analogously, aspects, which are described as part of a method step, also represent a description of a corresponding block or element or a property of a corresponding device. Exemplary embodiments can be based on the use of a machine learning model or machine learning model, respectively, or machine learning algorithm. Machine learning can refer to algorithms and statistical models, which can use computer systems, for carrying out a certain task without using explicit instructions, instead of depending on models and inference. In the case of machine learning, a transformation of data, which can be derived from an analysis of historical and/or training data, can be used, for example, instead of a transformation of data, which is based on rules. By training the machine learning model with a large number of training data and associated training content information (e.g. labels, annotations or “tags”), which indicate a desired output, the machine learning model “learns” a transformation between the data and the output. This can be used post-training in order to provide an output based on non-training data, which are geared towards the machine learning model. The provided data can be pre-processed in order to obtain a feature vector, which is used as input for the machine learning model. Machine learning models can be trained by using training data or training input data, respectively. The above-listed examples use a training method, which is referred to as “supervised learning”. In supervised learning, the machine learning model is trained by using a plurality of training sample values, wherein each sample value can comprise a plurality of input data values and a plurality of desired output values, i.e., each training sample may be associated with a desired output value. By providing both training sample values and desired output values, the machine learning model “learns”, which output value to provide based on an input sample vale, which is similar to the sample values provided during training. In addition to the supervised learning, semi-supervised learning can also be used. In semi-supervised learning, some of the training sample values lack a desired output value. Supervised learning can be based on a supervised learning algorithm (e.g. a classification algorithm, a regression algorithm or a similarity learning algorithm). Classification algorithms can be used when the outputs are limited to a finite set of values (categorical variables), i.e. the input is classified as one of the limited set of values. Regression algorithms can be used when the outputs exhibit some kind of numerical value (within a range). Similarity learning algorithms can be similar to classification as well as regression algorithms but rely on learning from examples by using a similarity function, which measures how similar or related two objects are. In addition to the supervised learning or semi-supervised learning, unsupervised learning can be used to train the machine learning model. In the case of the unsupervised learning, (only) input data may be provided, and an unsupervised learning algorithm can be used to find a structure in the input data (e.g. by grouping or clustering the input data, finding commonalities in the data). Clustering is the assignment of input data, which includes a plurality of input values, in subsets (clusters), such that input values within the same cluster are similar according to one or several (predefined) similarity criteria, while being dissimilar to input values encompassed in other clusters.

Reinforcement learning is a third group of machine learning algorithms. In reinforcement learning, one or several software agents (so-called “software agents”) are trained to perform actions in an environment. Based on the actions taken, a reward is calculated. Reinforcement learning is based on the training one or of the several software agents in order to select actions in such a way that the cumulative reward is increased, leading to software agents that improve in the task given to them (as evidenced by increasing rewards).

Furthermore, feature learning can further be used. Feature learning algorithms, also referred to as representation learning algorithms, can retain the information in their input, but transform it in such a way that it becomes useful, often as a pre-processing stage prior to carrying out the classification or the prediction tasks. Feature learning can be based, for example, on a principal component analysis or cluster analysis.

In the case of some examples, an anomaly detection (i.e. outlier detection) can be used, which is geared towards providing an identification of input values that raise suspicion because they differ significantly from the majority of input and training data.

In some examples, the machine learning algorithm can use a decision tree as prediction model. In a decision tree, observations about an object (e.g. a set of input values) can be represented by the branches of the decision tree, and an output value corresponding to the object can be illustrated by the leaves of the decision tree. Decision trees can support both discrete values as well as continuous values as output values. When discrete values are used, the decision tree can be referred to as classification tree, when continuous values are used, the decision tree can be referred to as regression tree. Association rules are a further technology, which can be used in the case of machine learning algorithms. Association rules are created by identifying relationships between variables in the case of large data sets are identified. The machine learning algorithm can identify and/or use one or several relational rules, which represent knowledge derived from the data. The rules can be used, e.g., to store, to manipulate or to apply knowledge. This knowledge can comprise features of audio data, which indicate the voice identity of a user, the voice of a third person, a non-speech noise originating from the user, stuttering and the like. The identification of these features can thus be improved continuously, which increases the reliability of the method.

Machine learning algorithms are usually based on a machine learning model. In other words, the term “machine learning algorithm” can refer to a set of instructions, which can be used to create, train or to use a machine learning model. The term “machine learning model” can refer to a data structure and/or a set of rules, which represents the learned knowledge (e.g., based on the training performed by the machine learning algorithm). In exemplary embodiments, the use of a machine learning algorithm can imply the use of an underlying machine learning model (or multiple underlying machine learning models). The use of a machine learning model can imply that the machine learning model and/or the data structure/the set of rules, which is/are the machine learning model, is trained by means of a machine learning algorithm.

For example, the machine learning model can be an artificial neural network (ANN). ANNs are systems inspired by biological neural networks found in a retina or a brain. ANNs consist of a multitude of interconnected nodes and a multitude of connections, so-called edges, between the nodes. Usually, there are three types of nodes, input nodes, which receive input values, hidden nodes, which are (only) connected to other nodes, and output nodes, which provide output values. Each node can represent an artificial neuron. Each edge can transmit information, from one node to the other. The output of a node can be defined as a (non-linear) function of the inputs (e.g. the sum of its inputs). The inputs of a node can be used in the function based on a “weight” of the edge or of the node, which provides the input. The weight of nodes and/or of edges can be adapted in the learning process. In other words, training of an artificial neural network can include adjusting the weights of the nodes and/or edges of the artificial neural network, i.e. in order to achieve a desired output for a certain input. One example for such a desired output is the conversion of the user's voice (but not other sounds) into an ego-dystonic target voice, which improves the user's speech performance.

Alternatively, the machine learning model can be a support vector machine, a random forest model or a gradient boosting model. Support vector machines are supervised learning models with assigned learning algorithms, which can be used for data analysis (e.g. in a classification or regression analysis). Support vector machines can be trained by providing an input with a multitude of training input values, which belong to one of two categories. The support vector machine can be trained to assign a new input value to one of the two categories. Alternatively, the machine learning model can be a Bayesian network, which is a probabilistic directed acyclic graphic model. A Bayesian network can represent a set of random variables and their conditional dependencies by using a directed acyclic graph. Alternatively, the machine learning model can be based on a genetic algorithm, which is a search algorithm and heuristic technique, which imitates the process of natural selection.

Exemplary embodiments of the invention can be realized in a computer system. The computer system can be a local computer device (e.g. a personal computer, laptop, tablet computer or mobile telephone) with one or several processors and one or several memory devices. The computer system can be a distributed computer system (e.g. a cloud computing system with one or several processors or one or several memory devices, which are distributed in different locations, for example at a local client and/or one or several remote server farms and/or data centres). The computer system can comprise any circuit or combination of circuits. In one exemplary embodiment, the computer system can comprise one or several processors, which can be of any type. The term “processor” is to preferably be understood as any type of computing circuit, such as, for example, a microprocessor, a microcontroller, a microprocessor with complex instruction set (CISC), a microprocessor with reduced instruction set (RISC), a very long instruction word (VLIW) microprocessor, a graphics processor, a digital signal processor (DSP), a multi-core processor, a field-programmable gate array (FPGA) or any other type of processor or processing circuit. Other types of circuits that can be included in the computer system, can be a custom-made circuit, an application-specific integrated circuit (ASIC) or the like, such as, for example, one or more circuits (e.g. a communication circuit) for the use in wireless devices, such as, e.g., mobile telephones, tablet computers, laptop computers, two-way radios and similar electronic systems. The computer system can comprise one or several memory devices, which can comprise one or several memory elements, which are suitable for the respective application, such as, for example, a main memory in the form of a RAM (random access memory), one or more hard drives and/or one or more drives, which handle removable media, such as, for example, CDs, flash memory cards, DVDs and the like. The computer system can also comprise a display device, one or several loudspeakers, and a keyboard and/or control, which can comprise a mouse, trackball, touchscreen, voice recognition device or any other device, which allows a system user to input information into the computer system and to receive information from it. The display device is preferably part of a graphical user interface (GUI).

This can enable the user to manually adjust the settings of the voice conversion system and/or to follow instructions, which are displayed on the user interface. Such settings can include adjusting the volume and the selection of an ego-dystonic target voice (e.g. a gender, a dialect, etc.). The displayed instructions can refer to the input of voice samples, in order to set up a voice identity on the voice conversion system.

It is pointed out expressly that the execution of the computer-based processes can take place within the described “mobile hearing system”. In particular, at least some of the processes described here can be performed, e.g., by a programmed processor of the hearing system and/or, e.g., by a programmed processor of the audio processing system.

In a special embodiment of the invention, the voice conversion method is implemented in a brain implant, which is suitable to modify hearing-related neurological events. Seo et al. 2021 (Network-on-chip for neurological data”, US patent 2021/0011870 A1) describe such an implant for receiving and processing neurological events of the brain tissue using electrodes. Preferably, in this implementation and execution on a brain implant, there is no functional connection between the actions (or method steps, respectively) performed on or by the device and the (potential) therapeutic effect exerted on the body by the device. The implementation and execution of the voice conversion method in a brain implant thus preferably does not represent a therapeutic treatment, such as the healing of diseases of the implant carrier, as well as no prophylactic measure for preventing a pathological condition.

Some or all method steps can be executed by (or using) a hardware device, such as, for example, a processor, a microprocessor, a programmable computer or an electronic circuit. In some exemplary embodiments, one or several of the most important method steps can be executed by means of such a device.

Depending on certain implementation requirements, exemplary embodiments of the invention can be implemented in hardware or software. The implementation can be executed by means of a non-volatile memory medium, such as a digital memory medium, such as, for example, a floppy disk, a DVD, a Blu-Ray, a CD, a ROM, a PROM and EPROM, an EEPROM or a FLASH memory, on which electronically readable control signals are stored, which interact (or can interact) with a programmable computer system so that the respective method is executed. The digital memory medium can thus be computer-readable.

Some exemplary embodiments according to the invention comprise a data carrier with electronically readable control signals, which can cooperate with a programmable computer system, so that one of the methods described herein is executed.

In general, exemplary embodiments of the present invention can be implemented as a computer program product with a program code, wherein the program code is effective for the execution of one of the methods when the computer program product runs on a computer. For example, the program code can be stored on a machine-readable carrier.

Further exemplary embodiments comprise the computer program for executing one of the methods described herein, which is stored on a machine-readable carrier.

In other words, one exemplary embodiment of the present invention is a computer program with a program code for executing one of the methods described herein, when the computer program runs on a computer.

A further exemplary embodiment of the present invention is a memory medium (or a data carrier or a computer-readable medium), which comprises a computer program stored thereon for executing one of the methods described herein, when executed by a processor.

The data carrier, the digital memory medium or the recorded medium are typically tangible and/or non-transitory. A further exemplary embodiment of the present invention is a device, as described herein, which comprises a processor and a memory medium.

A further exemplary embodiment of the invention is a data stream or a signal sequence, which represents the computer program for executing one of the methods described herein.

The data stream or the signal sequence can be configured, for example, to be transmitted via a data communication connection, for example via the Internet or a mobile radio connection (e.g. also 3G, 4G, 5G, LTE).

A further exemplary embodiment comprises a processing means, such as a computer or a programmable logic device, which is configured or adapted to execute one of the methods described herein.

A further exemplary embodiment comprises a computer, on which the computer program is installed for executing one of the methods described herein.

A further exemplary embodiment according to the invention comprises a device or a system, which is configured for transferring (for example electronically or optically) a computer program for executing one of the methods described herein to a receiver. The receiver can be, for example, a computer, a mobile device, a memory device or the like. The device or the system can comprise, for example, a file server for transferring the computer program to the receiver.

In some exemplary embodiments, a programmable logic device (e.g. a field-programmable gate array. FPGA) can be used to execute some or all functionalities of the methods described herein. In some exemplary embodiments, a field-programmable gate array can cooperate with a microprocessor in order to execute one of the methods described herein. In general, the methods can preferably be executed by any hardware device.

The embodiments described for one aspect of the invention can also be embodiments of any of the other aspects of the present invention. All embodiments and features described herein of the method according to the invention are also disclosed with regard to the computer-implemented method, the computer program, the system according to the invention and the hearing device. Accordingly, embodiments described for the method according to the invention can also be embodiments of the system according to the invention and of the hearing device. In addition, any embodiment described herein can also comprise features of any other embodiment of the invention. The various aspects of the invention are united by means of the common and surprising discovery of the unexpected advantageous effects of the present method, namely the improvement of the fluency of a user, benefit therefrom, are based thereon and/or are associated therewith.

In another aspect of the invention, the disclosed subject matter can be used as a non-invasive training method to improve the flow of words and/or speech of the user. This method is non-invasive, relying solely on acoustic intervention that changes the sensory or neural recognition of a subject's “own voice” to that of a “foreign voice”, thereby enhancing fluency. The method's potential training applications, not limited to these, include:
Facilitating motor learning and neural changes in a person who stutters, by enhancing the likelihood of repeated fluent speech episodes. Hence, the method could aid in reorganizing the neural circuits involved in speech production, particularly those that are known to be aberrant in stuttering according to the scientific literature [Chang S E, Garnett E O, Etchell A, Chow H M. Functional and Neuroanatomical Bases of Developmental Stuttering: Current Insights. Neuroscientist. 2019 December; 25(6):566-582. Doi: 10.1177/1073858418803594. Epub 2018 Sep. 28. PMID: 30264661; PMCID: PMC6486457]. There is broad evidence that repeated practice and experience can lead to changes in neural circuitry, allowing for functional recovery and adaptation following brain injury or dysfunction [Kleim, J. A., & Jones, T. A. (2008). Principles of experience-dependent neural plasticity: implications for rehabilitation after brain damage. Journal of Speech, Language, and Hearing Research, 51(1), S225-S239. DOI: 10.1044/1092-4388(2008/018)].
Retraining speech patterns, for example, to produce longer or more complex sentences which are typically challenging for individuals affected by stuttering.
Improving social interactions, self-efficacy expectations, and psychological well-being by successfully managing stuttering. By repeatedly exposing individuals to improved speech fluency, the method may help desensitize them to the fear of speaking, thus reducing speech anxiety.
Enhancing the efficacy of traditional speech therapy techniques when used in conjunction. For example, the experience of enhanced speech fluency can serve as a powerful motivator, demonstrating to the subjects their general capabilities and thereby inspiring them to achieve the desired therapy outcomes.

Accordingly further provided herein is a computer-implemented training method for improving the flow of words and/or speech of a subject, wherein the method is carried out by means of an audio processing device, in particular by means of a mobile electronic user device, by means of an audio processing device integrated into a wearable hearing system or by means of a server, wherein the method comprises at least the following steps:
receiving input audio information from an audio sensor device, which comprises at least one verbal utterance in a natural voice of the subject;
carrying out a voice conversion for generating output audio information in an ego-dystonic target voice, in that the at least one verbal utterance is converted as if the same speech content was produced by a different speaker, wherein the ego-dystonic target voice is a voice, which is identified by the subject as foreign voice in a sensory or neural manner by means of a neural mechanism of the auditory cortex for identifying a voice of the subject; and
prompting a reproduction, in particular a binaural reproduction, of the voice-converted output audio information to the subject, at least approximately in real time as feedback to the speaking of the subject.

Optionally, the said training method further comprises one or more of the various aspects and/or embodiments of the present disclosure or combinations thereof, especially those which correspond to the described functions of the audio processing device.

In another aspect of the invention, the herein disclosed subject-matter can be utilized as a method for treating fluency disorders.

In another aspect of the invention, the herein disclosed subject-matter can be utilized as a method for treating stuttering.

In view of all the foregoing disclosure, the present invention further relates to the following consecutively numbered embodiments:

Embodiment 1. An audio processing device (104), in particular a mobile electronic user device, an audio processing device integrated into a wearable hearing system or a server, wherein the audio processing device (104) is configured for:
receiving input audio information from an audio sensor device (106), which comprises at least one verbal utterance in a natural voice of a user;
carrying out a voice conversion (118) for generating output audio information in an ego-dystonic target voice, in that the at least one verbal utterance is converted as if the same speech content was produced by a different speaker; and
prompting a reproduction, in particular a binaural reproduction, of the voice-converted output audio information to the user at least approximately in real time as feedback to the speaking of the user.

Embodiment 2. The audio processing device (104) according to embodiment 1, wherein the ego-dystonic target voice is a voice, which is identified by the user as foreign voice, in particular identified in a sensory or neural manner, in particular by means of a neural mechanism of the auditory cortex for identifying a voice of the user; and/or
wherein the ego-dystonic target voice is a voice, which an algorithm for evaluating voice similarity, for example a biometric speaker identification system, identifies as foreign voice, i.e. no longer corresponding to the user, provided that this algorithm correlates with the subjective similarity perception of a human being when hearing voices; and/or
wherein the ego-dystonic target voice is a voice, which maintains the pitch of the natural voice of the user; and/or
wherein the ego-dystonic target voice is a voice, which maintains the natural fundamental frequency F0 of the natural voice of the user; and/or
wherein the ego-dystonic target voice is a voice, which has a lifelike or at least approximately lifelike voice naturalness; and/or
wherein the ego-dystonic target voice is a voice, which maintains or approximately maintains the natural quality of a human voice; and/or
wherein the ego-dystonic target voice is a voice, which is not solely based on a change of the pitch and/or a modification by means of frequency filtering.

Embodiment 3. The audio processing device (104) according to embodiment 1 or 2, wherein the audio processing device (104) for the voice conversion is at least partially configured based on a machine learning model;
wherein the machine learning model comprises a deep neural network (DNN), a recurrent neural network (RNN), a generative adversarial network (GAN) and/or a sequence-to-sequence mapping network (S2S); and/or
wherein the machine learning model is configured to carry out one or several of the following operations:
   reproducing individual natural and/or synthetic speaker voices, which are used for the machine learning;
   generating new speaker voices, which are not used for the machine learning; and/or
wherein the voice conversion, or at least parts thereof, takes place in a language-dependent manner (intra-lingually) or cross-lingually; and/or
wherein the voice conversion, or at least parts thereof, takes place in a gender-dependent manner (intra-gendered) or in a gender-independent manner (cross-gendered).

Embodiment 4. The audio processing device (104) according to any one of the preceding embodiments 1 to 3, wherein the ego-dystonic target voice is a voice, which deviates in at least one of the following features from the natural voice of the user: stretching, shortening, widening, constriction of the physiological vocal tract of the user.

Embodiment 5. The audio processing device (104) according to any one of the preceding embodiments 1 to 4, wherein the ego-dystonic target voice comprises an anti-voice, which maximally deviates from the natural voice of the user in at least one speaker-dependent, non-lingual voice feature;
wherein the at least one voice feature comprises:
   one or several speaker-dependent spectral properties, which depend directly on the configuration of the vocal tract, such as, for example, “Mel-frequency cepstral coefficients (MFCCs)”, “linear prediction cepstral coefficients (LPCCs)” and/or “perceptual linear prediction coefficients, and/or
   one or several speaker-dependent prosodic properties, such as, for example, “instantaneous energy”, “intonation”, “speech rate”, and/or “unit durations”; and/or
   one or several speaker-dependent features of the way of speaking, in particular of the linguistic dialect.

Embodiment 6. The audio processing device (104) according to embodiment 5, wherein the audio processing device (104) is further configured for:
determining at least one user-specific vocal feature, such as gender, age, features of the vocal tract and/or linguistic dialect in a setup phase, for example on the basis of at least one speech sample;
converting the at least one feature by using a voice conversion model, which is in particular based on machine learning, when carrying out the voice conversion; wherein the conversion comprises at least one of:
converting a male to a female voice and/or vice versa; and/or
   converting an old to a young voice and/or vice versa; and/or
   converting a stretched to a shortened vocal tract and/or vice versa; and/or
   converting a wide to a narrow vocal tract and/or vice versa; and/or
   converting a linguistic dialect, for example a Northern English dialect to a Southern English dialect.

Embodiment 7. The audio processing device (104) according to any one of the preceding embodiments 1 to 6, wherein the audio processing device (104) is further configured for: carrying out a voice anonymization or voice pseudo-anonymization for concealing the voice identity of the user in the output audio information.

Embodiment 8. The audio processing device (104) according to any one of the preceding embodiments 1 to 7, wherein the audio processing device (104) for the voice conversion for generating output audio information is further configured for:
capturing information relating to the head position, location and/or movements of the user, in particular by means of a wearable hearing system used by the user; and
using the captured information in order to add spatial audio references during the step of reproduction of the voice-converted output audio information, which are generated by 3D positional audio algorithms for the virtual placement of sound sources at any location in three-dimensional space, such as the “head-related transfer function”, which conveys a hearing impression as if the target voice originates from a predetermined ego-dystonic position within a three-dimensional acoustic space, for example, behind, above, in front of or below the user.

Embodiment 9. The audio processing device (104) according to any one of the preceding embodiments 1 to 8, wherein the audio processing device (104) is further configured for:
continuously changing a voice identity of the target voice;
wherein, optionally, the continuous change takes place so that a hearing impression of the target voice remains novel for the user; and/or
wherein the continuous change takes place according to a constant change rate G, at which the target voice changes step-by-step; and/or
wherein the change rate G corresponds to a speed, at which a first voice identity transitions completely into a second, perceivably different voice identity, wherein the change rate G is expressed in percent per second; and/or
wherein the change rate G is determined so that the changing takes place inconspicuously and/or below a perception threshold for acoustic changes.

Embodiment 10. The audio processing device (104) according to any one of the preceding embodiments 1 to 9, wherein the audio processing device (104) is further configured for:
in response to detecting a speech activity of the user, dividing sections of the input audio information into sections with speech and sections without speech, wherein the execution of the voice conversion to generate the output audio information is only based on the sections with speech;
wherein, optionally, the division is performed by means of a machine learning model; and
wherein, optionally, data of a structure-borne sound-related audio sensor system is observed and classified beforehand, in order to differentiate between vocal activity and non-vocal activity of the user, wherein only the part of the input audio information identified as vocal activity is transferred to the speech activity recognition.

Embodiment 11. The audio processing device (104) according to any one of the preceding embodiments 1 to 10, wherein the audio processing device (104) is further configured for:
adding a digital water mark, which is imperceptible for the user, to the output audio information, in order to make the target voice identifiable as artificially changed voice, in particular for systems and methods of the voice identification.

Embodiment 12. A wearable hearing device (102), comprising:
an audio sensor device (106) for capturing input audio information, which comprises at least one verbal utterance in a natural voice of a user;
means for transferring the input audio information to an audio processing device (104) and for receiving voice-converted output audio information from the audio processing device (104) in an ego-dystonic target voice, in that the at least one verbal utterance has been converted (118) as if the same speech content was produced by a different speaker; and
an audio output device (110) for reproducing, in particular binaural reproducing, the voice-converted output audio information to the user at least approximately in real time as feedback to the speaking of the user;
wherein the audio processing device (104) is preferably an audio processing device (104) according to any one of the preceding embodiments 1 to 11.

Embodiment 13. A voice conversion system (100), comprising:
an audio processing device (104) according to any one of the preceding embodiments 1 to 11; and
a wearable hearing device (102) according to embodiment 12.

Embodiment 14. A computer-implemented voice conversion method for improving the flow of speech in the case of fluency disorders, in particular in the case of stuttering, wherein the method is carried out by means of an audio processing device (104), in particular by means of a mobile electronic user device, by means of an audio processing device integrated into a wearable hearing system or by means of a server, wherein the method comprises at least the following steps:
receiving input audio information from an audio sensor device (106), which comprises at least one verbal utterance in a natural voice of a user;
carrying out a voice conversion (118) for generating output audio information in an ego-dystonic target voice, in that the at least one verbal utterance is converted as if the same speech content was produced by a different speaker; and
prompting a reproduction, in particular a binaural reproduction, of the voice-converted output audio information to the user, at least approximately in real time as feedback to the speaking of the user;
wherein, optionally, the method further comprises one of the several steps, which correspond to the function of the audio processing device (104) according to any one of the preceding embodiments 2 to 11.

Embodiment 15. A computer program or a computer-readable memory medium, on which the computer program is stored, wherein the computer program comprises commands, which, when executing the program by a computer, prompt the latter to execute the method according to embodiment 14.

In addition or alternatively to the above numbered embodiments, also the following embodiments form part of the present disclosure:

Embodiment 16. The audio processing device (104) according to any one of the embodiments 1 to 5, wherein the audio processing device (104) is further configured to perform an algorithm to determine maximal dissimilarity from the user's natural voice, and wherein maximal dissimilarity is quantitatively determined by one or more of the following criteria:
a dissimilarity score that surpasses a predetermined threshold value as quantified by the Euclidean distance metric;
a percentile ranking where the anti-voice is positioned within the top 30%, preferably within the top 20%, and more preferably within the top 10%, in terms of distance from the user's voice, as calculated in a voice similarity matrix;
a dissimilarity value that exceeds a specific number of standard deviations above the mean value in the dataset, preferably one standard deviation, and more preferably two standard deviations;
a comparative measure where the dissimilarity of the anti-voice is classified as falling within the highest 30% or the farthest 30% of all target-voices from the user's voice within a voice similarity matrix;
an absolute cut-off point, established based on empirical evidence or expert consensus, beyond which the dissimilarity score of any voice is considered maximal for the purpose of human sensory-based voice recognition;
and wherein the conversion is carried out based on the determined maximal dissimilarity from the user's natural voice, by using a voice conversion model.

Embodiment 17. The audio processing device (104) according to any one of the embodiments 1 to 6, wherein the audio processing device (104) is further configured to perform an algorithm to determine maximal dissimilarity from the user's natural voice in at least one acoustic parameter critical for the human neural or sensorial recognition of a voice identity, and wherein maximal dissimilarity is determined by one or more of the following criteria:
the respective parameter exhibits maximal dissimilarity if its measurement surpasses a pre-established threshold in the Euclidean distance metric, signifying a substantial deviation from the respective parameter in the user's natural voice;
the respective parameter exhibits maximal dissimilarity if ranked within the top 30%, preferably within the top 20%, and most preferably within the top 10%, in terms of its distance from the corresponding parameter of the user's voice, as assessed in a parameter-specific similarity matrix;
the respective parameter exhibits maximal dissimilarity when its value is several standard deviations above the dataset's mean for that specific parameter, preferably one standard deviation, and more preferably two standard deviations;
a comparative measure is utilized where maximal dissimilarity in the respective parameter is classified when it is ranked within the highest 30% or as one of the farthest 30% measurements from the user's corresponding voice parameter in a parameter-specific similarity matrix;
an absolute cut-off point, established based on empirical evidence or expert consensus, beyond which the dissimilarity score of the respective parameter is considered maximal for the purpose of human sensory-based voice recognition;
and wherein the conversion of the at least one acoustic parameter is carried out based on the determined maximal dissimilarity, by using a voice conversion model.

Embodiment 18. The audio processing device (104) for the use according to any one of the embodiments 1 to 11, wherein the audio processing device (104) is configured to continuously improve the ego-dystonic target voice based on input audio information characterizing the user's speech fluency.

Embodiment 19. The audio processing device (104) for the use according to the embodiment 18, wherein the ego-dystonic target voice (104) is altered based on a quantification of the improvement in the user's speech fluency when exposed to various ego-dystonic target voices or anti-voices.

Embodiment 20. The audio processing device (104) for the use according to embodiment 18 or 19, wherein the audio processing device (104) is configured to apply a machine learning model, in particular a machine learning-based, self-adaptive model, wherein the model is configured to:
dynamically alter one or more audio parameters of the target voice, including but not limited to formant frequencies (timbre) and harmonics, in response to indicators of speech fluency; and/or
continuously refine the one or more audio parameter adjustments based on successful speech outcomes, such as a quantified reduction in the frequency of stuttering events for the specific user or user group; and/or
utilize an iterative process for customizing the voice conversion for each individual, thereby optimizing speech fluency through personalized auditory manipulation.

1. An audio processing device (104), in particular a mobile electronic user device, an audio processing device integrated into a wearable hearing system or a server, for improving the flow of words in fluency disorders, in particular in the case of stuttering, wherein the audio processing device (104) is configured for:
receiving input audio information from an audio sensor device (106), which comprises at least one verbal utterance in a natural voice of a user;
carrying out a voice conversion (118) for generating output audio information in an ego-dystonic target voice, wherein the ego-dystonic target voice is a voice, which is identified by the user as a foreign voice of another speaker in a sensory or neural manner by means of a neural mechanism of the auditory cortex for identifying the voice of the user, wherein carrying out the voice conversion comprises:
calculating a quantifiable self-dissimilarity value for each of multiple target voices using a Euclidean distance method where the target voices and the user's voice are each represented as points in a multidimensional acoustic feature space;
performing an algorithm to determine maximal dissimilarity from the user's voice, wherein maximal dissimilarity is quantitatively determined by one or more of the following criteria:
a dissimilarity value that surpasses a predetermined threshold value as quantified by the Euclidean distance metric;
a percentile ranking where the target voice is positioned within the top 30% in terms of distance from the user's voice, as calculated in a voice similarity matrix;
a dissimilarity value that exceeds a specific number of standard deviations above the mean value in the dataset;
based on the determined maximal dissimilarity from the user's natural voice, manipulating formant frequencies and/or spectral features and/or timbre while maintaining the natural fundamental frequency f0 of the voice of the user, thereby converting the at least one verbal utterance as if the same speech content was produced by a different speaker; and
prompting a reproduction, in particular a binaural reproduction, of the voice-converted output audio information to the user as acoustic feedback to the speaking of the user;
wherein the audio processing device (104) is further configured for continuously changing a voice identity of the target voice to prevent adaptation by the user.

2. The audio processing device (104) for the use according to claim 1,
wherein the ego-dystonic target voice is a voice, which maintains the pitch of the natural voice of the user; and/or
wherein the ego-dystonic target voice is a voice, which has a lifelike or at least approximately lifelike voice naturalness; and/or
wherein the ego-dystonic target voice is a voice, which maintains or approximately maintains the natural quality of a human voice; and/or
wherein the ego-dystonic target voice is a voice, which is not solely based on a change of the pitch and/or a modification by means of frequency filtering.

3. The audio processing device (104) for the use according to claim 1, wherein the audio processing device (104) for the voice conversion is at least partially configured based on a machine learning model;
wherein the machine learning model comprises a deep neural network (DNN), a recurrent neural network (RNN), a generative adversarial network (GAN) and/or a sequence-to-sequence mapping network (S2S); and/or
wherein the machine learning model is configured to carry out one or several of the following operations:
reproducing individual natural and/or synthetic speaker voices, which are used for the machine learning;
generating new speaker voices, which are not used for the machine learning; and/or
wherein the voice conversion, or at least parts thereof, is carried out in a language-dependent manner (intra-lingually) or cross-lingually; and/or
wherein the voice conversion, or at least parts thereof, is carried out in a gender-dependent manner (intra-gendered) or in a gender-independent manner (cross-gendered).

4. The audio processing device (104) for the use according to claim 1, wherein the ego-dystonic target voice is a voice, which deviates in at least one of the following features from the natural voice of the user:
stretching, shortening, widening, constriction of the physiological vocal tract of the user.

5. The audio processing device (104) for the use according to claim 1, wherein the ego-dystonic target voice comprises an anti-voice, which maximally deviates from the natural voice of the user in at least one speaker-dependent, non-lingual voice feature;
wherein the at least one voice feature comprises:
one or several speaker-dependent spectral properties, which depend directly on the configuration of the vocal tract, such as, for example, “Mel-frequency cepstral coefficients (MFCCs)”, “linear prediction cepstral coefficients (LPCCs)” and/or “perceptual linear prediction coefficients, and/or
one or several speaker-dependent prosodic properties, such as, for example, “instantaneous energy”, “intonation”, “speech rate”, and/or “unit durations”; and/or
one or several speaker-dependent features of the way of speaking, in particular of the linguistic dialect.

6. The audio processing device (104) for the use according to claim 1, wherein:
a percentile ranking where the anti-voice is positioned within the top 20%, and more preferably within the top 10%, in terms of distance from the user's voice, as calculated in a voice similarity matrix;
a dissimilarity value that exceeds a specific number of standard deviations above the mean value in the dataset, namely one standard deviation, and more preferably two standard deviations;
a comparative measure where the dissimilarity of the anti-voice is classified as falling within the highest 30% or the farthest 30% of all target-voices from the user's voice within a voice similarity matrix;
an absolute cut-off point, established based on empirical evidence or expert consensus, beyond which the dissimilarity score of any voice is considered maximal for the purpose of human sensory-based voice recognition.

7. The audio processing device (104) for the use according to claim 1, wherein the audio processing device (104) is further configured to perform an algorithm to determine maximal dissimilarity from the user's natural voice in at least one acoustic parameter critical for the human neural or sensorial recognition of a voice identity, and wherein maximal dissimilarity is determined by one or more of the following criteria:
the respective parameter exhibits maximal dissimilarity if its measurement surpasses a pre-established threshold in the Euclidean distance metric, signifying a substantial deviation from the respective parameter in the user's natural voice;
the respective parameter exhibits maximal dissimilarity if ranked within the top 30%, preferably within the top 20%, and most preferably within the top 10%, in terms of its distance from the corresponding parameter of the user's voice, as assessed in a parameter-specific similarity matrix;
the respective parameter exhibits maximal dissimilarity when its value is several standard deviations above the dataset's mean for that specific parameter, preferably one standard deviation, and more preferably two standard deviations;
a comparative measure is utilized where maximal dissimilarity in the respective parameter is classified when it is ranked within the highest 30% or as one of the farthest 30% measurements from the user's corresponding voice parameter in a parameter-specific similarity matrix;
an absolute cut-off point, established based on empirical evidence or expert consensus, beyond which the dissimilarity score of the respective parameter is considered maximal for the purpose of human sensory-based voice recognition;
and wherein the conversion of the at least one acoustic parameter is carried out based on the determined maximal dissimilarity, by using a voice conversion model.

8. The audio processing device (104) for the use according to claim 5, wherein the audio processing device (104) is further configured for:
determining at least one user-specific vocal feature, such as gender, age, features of the vocal tract and/or linguistic dialect in a setup phase, for example on the basis of at least one speech sample;
converting the at least one feature by using a voice conversion model, which is in particular based on machine learning, when carrying out the voice conversion;
wherein the conversion comprises at least one of:
converting a male to a female voice and/or vice versa; and/or
converting an old to a young voice and/or vice versa; and/or
converting a stretched to a shortened vocal tract and/or vice versa; and/or
converting a wide to a narrow vocal tract and/or vice versa; and/or
converting a linguistic dialect, for example a Northern English dialect to a Southern English dialect.

9. The audio processing device (104) for the use according to claim 1, wherein the audio processing device (104) is further configured for: carrying out a voice anonymization or voice pseudo-anonymization for concealing the voice identity of the user in the output audio information.

10. The audio processing device (104) for the use according to claim 1, wherein the audio processing device (104) for the voice conversion for generating output audio information is further configured for:
capturing information relating to the head position, location and/or movements of the user, in particular by means of a wearable hearing system used by the user; and
using the captured information in order to add spatial audio references during the step of the reproduction of the voice-converted output audio information, which audio references are created by algorithms of the 3D position audio for virtually placing sound sources at any point in the three-dimensional space, such as the “head-related transfer function”, which give an auditory impression as if the target voice originates from a predetermined ego-dystonic position within a three-dimensional acoustic space, for example, behind, above, in front of or below the user.

11. The audio processing device (104) for the use according to claim 1, wherein the continuous change takes place so that a hearing impression of the target voice remains novel for the user; and/or
wherein the continuous change takes place according to a constant change rate G, at which the target voice changes step-by-step; and/or
wherein the change rate G corresponds to a speed, at which a first voice identity transitions completely into a second, perceivably different voice identity, wherein the change rate G is expressed in percent per second; and/or
wherein the change rate G is determined so that the changing takes place inconspicuously and/or below a perception threshold for acoustic changes.

12. The audio processing device (104) for the use according to claim 1, wherein the audio processing device (104) is further configured for:
in response to detecting a speech activity of the user, dividing sections of the input audio information into sections with speech and sections without speech, wherein the execution of the voice conversion to generate the output audio information is only based on the sections with speech;
wherein, optionally, the division is performed by means of a machine learning model; and
wherein, optionally, data of a structure-borne sound-related audio sensor system is observed and classified beforehand in order to differentiate between vocal activity and non-vocal activity of the user, wherein only the part of the input audio information identified as vocal activity is transferred to the speech activity recognition.

13. The audio processing device (104) for the use according to claim 1, wherein the audio processing device (104) is further configured for:
adding a digital water mark, which is imperceptible for the user, to the output audio information in order to make the target voice identifiable as artificially changed voice, in particular for systems and methods of voice identification.

14. The audio processing device (104) for the use according to claim 1, wherein the audio processing device (104) is configured to continuously improve the ego-dystonic target voice based on input audio information characterizing the user's speech fluency.

15. The audio processing device (104) for the use according to claim 14, wherein the ego-dystonic target voice (104) is altered based on a quantification of the improvement in the user's speech fluency when exposed to various ego-dystonic target voices or anti-voices.

16. The audio processing device (104) for the use according to claim 14, wherein the audio processing device (104) is configured to apply a machine learning model, in particular a machine learning-based, self-adaptive model, wherein the model is configured to:
dynamically alter one or more audio parameters of the target voice, including but not limited to formant frequencies (timbre) and harmonics, in response to indicators of speech fluency; and/or
continuously refine the one or more audio parameter adjustments based on successful speech outcomes, such as a quantified reduction in the frequency of stuttering events for the specific user or user group; and/or
utilize an iterative process for customizing the voice conversion for each individual, thereby optimizing speech fluency through personalized auditory manipulation.

17. A wearable hearing device (102) for improving the flow of words in fluency disorders, in particular in the case of stuttering, comprising:
an audio sensor device (106) for capturing input audio information, which comprises at least one verbal utterance in a natural voice of a user;
means for transferring the input audio information to an audio processing device (104) and for receiving voice-converted output audio information from the audio processing device (104) in an ego-dystonic target voice, in that the at least one verbal utterance has been converted (118) as if the same speech content was produced by a different speaker by manipulating formant frequencies and/or spectral features and/or timbre while maintaining the natural fundamental frequency f0 of the voice of the user;
wherein the ego-dystonic target voice is a voice, which is identified by the user as a foreign voice in a sensory or neural manner by means of a neural mechanism of the auditory cortex for identifying the voice of the user; and
an audio output device (110) for reproducing, in particular binaural reproducing, the voice-converted output audio information to the user as acoustic feedback to the speaking of the user; and
wherein the audio processing device (104) is an audio processing device (104) according to claim 1.

18. A voice conversion system (100) for improving the flow of words in fluency disorders, in particular in the case of stuttering, comprising:
an audio processing device (104) according to claim 1; and
a wearable hearing device (102).

19. A computer-implemented voice conversion method for improving the flow of speech in the case of fluency disorders, in particular in the case of stuttering, wherein the method is carried out by means of an audio processing device (104), in particular by means of a mobile electronic user device, by means of an audio processing device integrated into a wearable hearing system or by means of a server, wherein the method comprises at least the following steps:
receiving input audio information from an audio sensor device (106), which comprises at least one verbal utterance in a natural voice of a user;
carrying out a voice conversion (118) for generating output audio information in an ego-dystonic target voice, wherein the ego-dystonic target voice is a voice, which is identified by the user as foreign voice of another speaker in a sensory or neural manner by means of a neural mechanism of the auditory cortex for identifying the voice of the user, wherein carrying out the voice conversion comprises:
calculating a quantifiable self-dissimilarity value for each of multiple target voices using a Euclidean distance method where the target voices and the user's voice are each represented as points in a multidimensional acoustic feature space;
performing an algorithm to determine maximal dissimilarity from the user's voice, wherein maximal dissimilarity is quantitatively determined by one or more of the following criteria:
a dissimilarity value that surpasses a predetermined threshold value as quantified by the Euclidean distance metric;
a percentile ranking where the target voice is positioned within the top 30% in terms of distance from the user's voice, as calculated in a voice similarity matrix;
a dissimilarity value that exceeds a specific number of standard deviations above the mean value in the dataset;
based on the determined maximal dissimilarity from the user's natural voice, manipulating formant frequencies and/or spectral features and/or timbre while maintaining the natural fundamental frequency f0 of the voice of the user, thereby converting the at least one verbal utterance as if the same speech content was produced by a different speaker; and
prompting a reproduction, in particular a binaural reproduction, of the voice-converted output audio information to the user as acoustic feedback to the speaking of the user;
wherein the method further comprises continuously changing a voice identity of the target voice to prevent adaptation by the user;
wherein, optionally, the method further comprises one of the several steps, which correspond to the function of the audio processing device (104) according to claim 2.

20. A computer-implemented training method for improving the flow of words and/or speech of a user, wherein the method is carried out by means of an audio processing device (104), in particular by means of a mobile electronic user device, by means of an audio processing device integrated into a wearable hearing system or by means of a server, wherein the method comprises at least the following steps:
receiving input audio information from an audio sensor device (106), which comprises at least one verbal utterance in a natural voice of the user;
carrying out a voice conversion (118) for generating output audio information in an ego-dystonic target voice, wherein the ego-dystonic target voice is a voice, which is identified by the user as foreign voice of another speaker in a sensory or neural manner by means of a neural mechanism of the auditory cortex for identifying a voice of the user, wherein carrying out the voice conversion comprises:
calculating a quantifiable self-dissimilarity value for each of multiple target voices using a Euclidean distance method where the target voices and the user's voice are each represented as points in a multidimensional acoustic feature space;
performing an algorithm to determine maximal dissimilarity from the user's voice, wherein maximal dissimilarity is quantitatively determined by one or more of the following criteria:
a dissimilarity value that surpasses a predetermined threshold value as quantified by the Euclidean distance metric;
a percentile ranking where the target voice is positioned within the top 30% in terms of distance from the user's voice, as calculated in a voice similarity matrix;
a dissimilarity value that exceeds a specific number of standard deviations above the mean value in the dataset;
based on the determined maximal dissimilarity from the user's natural voice, manipulating formant frequencies and/or spectral features and/or timbre while maintaining the natural fundamental frequency f0 of the voice of the user, thereby converting the at least one verbal utterance as if the same speech content was produced by a different speaker; and
prompting a reproduction, in particular a binaural reproduction, of the voice-converted output audio information to the subject as acoustic feedback to the speaking of the user;
wherein the method further comprises continuously changing a voice identity of the target voice to prevent adaptation by the user;
wherein, optionally, the training method further comprises one of the several steps, which correspond to the function of the audio processing device (104) according to claim 2.

21. A computer program or a computer-readable memory medium, on which the computer program is stored, wherein the computer program comprises commands, which, when executing the program by a computer, prompt the latter to execute the method according to claim 19.
